(19) United States
(12) Patent Application Publication
(10) Pub. No.: US 2023/0222328 A1
(43) Pub. Date: Jul. 13, 2023

(54) Solving Aliasing-Induced Problems in Convolutional Nonlinear Networks

(71) Applicant: Emmy Wei, San Jose, CA (US)

(72) Inventor: Emmy Wei, San Jose, CA (US)

(21) Appl. No.: 18/095,257

(22) Filed: Jan. 10, 2023

Related U.S. Application Data
(60) Provisional application No. 63/298,218, filed on Jan. 11, 2022.

(51) Int. Cl. G06N 3/0464; G06N 3/048

(52) U.S. Cl. CPC G06N 3/0464; G06N 3/048

(57) ABSTRACT

Methods are disclosed for aliasing-free nonlinear signal processing, by implementing non-polynomial operations as implicitly defined functions that are computed iteratively using linear shift-invariant convolutions in conjunction with polynomial operations, where upsampling and/or downsampling of signals are employed to control their spectra and avoid aliasing completely. Techniques of system or image symmetrization are also disclosed to render a convolutional nonlinear network shift-invariant under an arbitrary spacetime shift.

### CROSS-REFERENCE TO RELATED APPLICATIONS

The present application claims the benefit under 35 U.S.C. § 119(e) of U.S. Provisional Application Ser. No. 63/298,218, filed Jan. 11, 2022. Said U.S. Provisional Application Ser. No. 63/298,218 is hereby incorporated by reference in its entirety.

### FIELD

This invention relates to digital signal processing and convolutional nonlinear networks, specifically to solving the problem of aliasing induced by non-polynomial functions or operations.

### BACKGROUND

### General Background

In this specification, the terms signal and image are used interchangeably to refer to a physical quantity, or its digitized representation on a computer, that is distributed in a region of space or time, or spacetime jointly. Also, the terms system and network of signal processing are used interchangeably to refer to either a physical device or method of signal processing that is represented by a directed graph of signal transformations. Mathematically, such a system or network corresponds to and realizes a composite function mapping input signals to output signals.

The advent and wide applications of modern digital computers have made computing and signal processing ubiquitous and indispensable in industries, scientific researches, and daily lives. Digital signal processing relies on the Nyquist-Shannon sampling theorem [1], which guarantees bidirectional lossless conversion between a band-limited continuous signal and its discretely sampled digital representation, provided that the rate (i.e., frequency) of sampling satisfies the Nyquist criterion, namely, the sampling rate is at least twice the bandwidth of the continuous signal [1].

However, a nonlinear function in a convolutional nonlinear network (CNN) can create new frequency components beyond the spectral band of the original continuous signal, leading to aliasing in discrete samples and spoiling the signal integrity. Aliasing-induced problems causes loss of symmetries, particularly loss of shift invariance in a CNN, namely, a spacetime shift of an input image leads to a substantial difference in the output image, that is not undone by a backward shift.

In CNN-based pattern recognition, aliasing-induced shift variance could cause significant performance fluctuations and degradations under image offsets. Such shift variance is extremely detrimental in computational lithography [2,3] for integrated circuit (IC) manufacturing, as identical IC design patterns aligned differently with respect to a grid of simulation images will produce different results, leading to significant variations among devices that are designed and desired to be identical.

Definition 1. A CNN is an interconnected network of signal processing 114_1 comprising the following four types of functional element: 1) a linear convolution, 2) a spacetime-independent pointwise nonlinear operation on a signal in spacetime, 3) a fan-out creating multiple copies of an input signal, 4) a linear combination of multiple input signals into one output signal.

Aliasing is a well-known problem in CNNs, which is especially difficult to solve or avoid when a non-polynomial function is involved, because such non-polynomial signal operation can generate frequency components that are arbitrarily far away from the original spectral band without limitation, although their amplitudes become smaller as they get further away. In fact, convolutional neural networks (called neural CNNs hereafter) [5-8], which have gained great popularity in the recent machine learning renaissance, involve mostly non-polynomial activation functions, including the rationals, sigmoid, hyperbolic tangent, ReLU, Swish, max pooling, Softmax, and SoftPool, etc. [9-14]. These activation functions create significant high-frequency contents beyond the sampling rates of the signals and cause aliasing. Neural CNNs often employ downsampling to achieve hierarchical feature extraction, which is usually done straightforwardly in the spacetime domain without spectrum control. Significant aliasing is caused by such straightforward downsampling, which shall be referred to as aliasing-prone downsampling (AP-downsampling) hereafter.

### Prior Art

Despite explicitly employing shift-invariant convolutions, neural CNNs have not been truly shift-invariant since their initial introduction [5-8], due to the non-polynomial activation functions and AP-downsampling. How to make CNNs truly shift-invariant has been an open problem for more than thirty years. There is even a commonly held belief that aliasing can only be reduced but not rid of completely whenever a non-polynomial function is involved. Practically, recent studies have shown that image classification and speech recognition systems based on neural CNNs are indeed impaired by aliasing-induced problems. In refs. [15-17], it has been found that a slight spatial shift of input images, as small as a single pixel and indiscernible to human eyes, can lead to significantly different classification outputs in pattern recognition applications using multi-layered convolutional neural networks. Ref. [18] demonstrated the impact of aliasing on audio and speech processing via deep convolutional neural networks. Aliasing-induced effects are particularly problematic for generative models employing autoencoders [19-21]. Partial solutions such as spatiotemporal blurring before spacetime downsampling have been proposed and tested in applications [20, 22, 23], which could mitigate the problems of aliasing but not remove them completely. A consensus in the field is that “the problem of insuring invariance to small image transformations in neural networks while preserving high accuracy remains unsolved” [17].

Another class of nonlinear systems is called Wiener-Padé CNNs, which are based on the classical Volterra-Wiener models [4,24,25] involving convolutions and polynomial functions, then extended to include rational functions (Padé approximants) [11, 12, 26]. Such Wiener-Padé CNNs have been widely applied in the fields of computational physics and engineering, especially computational lithography [2, 3, 27-29], where the continuous distribution of an input physical quantity (e.g., intensity of an optical image) is near-Nyquist sampled and losslessly represented by an input discrete image, which is processed by a Wiener-Padé network to produce an output discrete image representing the continuous distribution of an output physical quantity (e.g., topography of a developed photoresist). Usually, such Wiener-Padé CNNs do not perform AP-downsampling, but they often critically sample continuous distributions close to their Nyquist limits for computational efficiency, while demand lithography patterns be simulated to an accuracy well below the sampling grid size of the discrete images. In particular, they require strict shift-invariance under any spacetime translation, including a fraction of the sampling grid. Indeed, in computational lithography, discrete images are usually with a grid size of tens of nanometers, while a shift variance of one or a few tenths of nanometer in simulated lithography patterns is considered a significant source of error. There has not been a solution to avoid such aliasing-induced shift variance when pointwise division is performed often or a sigmoid-like function is involved occasionally.

### Objects and Advantages

This specification discloses a fundamental solution to the thirty-year-old open problem of aliasing in general CNNs involving non-polynomial functions, which include both the Wiener-Padé and the convolutional neural networks. The key method is to implement non-polynomial operations as implicitly defined functions, which are numerically computed via iterative algorithms involving only linear operations and pointwise multiplications, where proper spectrum control is incorporated to thoroughly avoid aliasing. Novel methods are disclosed to realize non-polynomial functions commonly used in CNNs. In particular, exemplary embodiments are specified to implement aliasing-free operations of Wiener-Padé CNNs. Some of the methods have been published in an open archive [30] as well as a peer-reviewed, indexed journal [31], and are incorporated by reference herein. It may be noted that the present method of implicit functions is able to remove all aliasing-induced problems completely and achieve absolute shift-invariance under any spacetime translations, albeit at the cost of a constant computational overhead, in relation to the number of algorithmic iterations that usually ranges from 6 to 10.

On the other hand, for many applications using neural CNNs, shift-invariance is only required under spacetime translations in units of pixels of the input image, where no fractional-pixel translation is of concern, but there are periodic shift variances caused by AP-downsampling. Then, methods of symmetric summation and optimal image positioning are proposed to have signals within a period either averaged or represented by a unique delegate so that the neural CNNs produce a shift-invariant result. Algorithms and exemplary applications in image denoising using autoencoders are presented to illustrate the method and validate the desired shift-invariance. The related TensorFlow Keras source codes are published in GitHub [32]. Although limited to spacetime translations, the symmetrization techniques have the advantage of incurring no or negligible computational cost. In particular, the method of optimal image positioning extends to any spacetime translation by an arbitrary fraction of the image pixel.

### SUMMARY

Methods are disclosed for solving the problem of aliasing in CNNs employing non-polynomial functions or AP-downsampling. This settles a long-outstanding open problem and addresses a pressing need in nonlinear signal processing. The key to the solution is to implement non-polynomial operations via implicitly defined functions and compute them through algorithmic iterations involving polynomials in conjunction with spectrum control, which ensures that the spectrum of a signal is never broadened to beyond the discrete sampling frequency during polynomial operations and always narrowed properly before downsampling.

For neural CNNs that only require invariance under integral shifts, AP-downsampling is identified as the sole culprit of shift variance, and the notion of stride-invariance is recognized and employed to render a general neural CNN integral shift-invariant by symmetrizing the network or the input images. In particular, a spectrum-based order is defined for comparing the subimages of each input, based on which optimal image positioning is done without collision and ambiguity, leading to an efficient method to make any CNN shift-invariant under an arbitrary shift, without incurring a sizable computational overhead.

### BRIEF DESCRIPTION OF THE DRAWINGS

FIG. 1 shows an original test image in real space and its power spectral density.

FIG. 2 shows the output image and its power spectral density from the explicit Wiener-Padé function, when the input image is 2×upsampled.

FIG. 3 shows contours of predicted lithography patterns extracted from a resist image.

FIG. 4 shows the output image and its power spectral density from the implicitly defined Wiener-Padé function.

FIG. 5 shows a (6,4)-sized image I decomposed into four stride-(2, 2) subimages I_{(0,0)}, I_{(1,0)}, I_{(0,1)}, and I_{(1,1)} that are filled with dots, horizontal dashes, vertical dashes, and unfilled respectively.

FIG. 6 shows a neural CNN module made shift-invariant by symmetric summation.

FIG. 7 shows a preprocessor for optimal image positioning placed before a neural CNN.

FIG. 8 shows a two-level autoencoder for image denoising.

FIG. 9 shows samples of MNIST images at the top, their noisy counterparts in the middle, and denoised images from the denoiser NumberDenoiseStill at the bottom.

FIG. 10 shows the training losses and the RSV vs. integral shifts of NumberDenoiseStill.

FIG. 11 shows the shift variance of a typical image processed by NumberDenoiseStill.

FIG. 12 shows the training losses and the RSV vs. integral shifts of NumberDenoiseInvar.

FIG. 13 shows samples of MNIST images at the top, their noisy counterparts in the middle, and denoised images from the denoiser NumberDenoiseInvar at the bottom.

FIG. 14 shows the shift variance in a typical image processed by NumberDenoiseInvar.

FIG. 15 illustrates a method or process for implementing a non-polynomial operation.

FIG. 16 illustrates an exemplary embodiment of an essentially polynomial transformation.

FIG. 17 illustrates a method or process for making a shift-variant input-output system shift-invariant.

### DETAILED DESCRIPTION

### Mathematical Analyses of DSP and Aliasing

Let an interested region of spacetime be coordinated by a variable vector x∈ [symbol] ^{d}, d∈ [symbol] and I(x) denote an interested signal over the spacetime region. For any given coordinate shift δx∈ [symbol] ^{d}, let T_{δx} denote a spacetime translation operator such that [T_{δx}I](x) [symbol] I(x+δX), with T_{δx}I representing the coordinate-shifted version of I. It is easy to see that for any δx∈ [symbol] ^{d}, the operator T_{δx} is invertible and T_{δx}⁻¹=T_{-δx}.

Definition 2. A function ƒ on continuous signals is called shift-invariant or translation-invariant, if ƒ(T_{δx}I)=T_{δx}[ƒ(I)] holds for any legitimate input signal I and for any coordinate shift δx. For a given δx∈ [symbol] ^{d}, let ƒ_{δx} [symbol] T_{δx}⁻¹ƒT_{δx} [symbol] T_{δx}⁻¹∘ƒ∘T_{δx} denote a composite function that shifts an input signal forward by δx, then applies the function ƒ, and finally shifts the resulted signal backward by −δx. Equivalently, a function ƒ is translation-invariant if and only if ƒ_{δx}=ƒ holds for any δx∈ [symbol] ^{d}. A function or system is called LTI when it is both linear and translation-invariant. A function or system ƒ is not shift-invariant, or said to violate the symmetry of shift-invariance, when a legitimate input image I and a coordinate shift δx∈ [symbol] ^{d} exist such that ƒ_{δx}(I)≠ƒ(I).

The celebrated Nyquist-Shannon sampling theorem [1] states that if a continuous signal in spacetime has a finite bandwidth W, then it can be sampled into a discrete signal at a sampling rate R>2W, and such continuous-to-discrete (also called analog-to-digital) signal conversion is information lossless, in the sense that, whenever needed, the original continuous signal can be fully recovered from the sampled discrete signal using the Whittaker-Shannon interpolation formula [1]. This is the foundation of digital signal processing (DSP).

To analyze a DSP system operating at a sampling rate R, let S denote the operation of sampling a continuous band-limited signal I into a discrete image array J=S(I), and conversely, let S* represent the reverse operation of reconstructing a continuous band-limited signal I′=S*(J′) from a discrete image array J′ via the Whittaker-Shannon interpolation. The operator composition SS* [symbol] S∘S* always reduces to an identity operator, transforming any discrete image array back to itself, while S*S [symbol] S*∘S maps identically only for band-limited signals with a bandwidth W<R/2. It is another manifest of aliasing that S*S does not reduce to the identity operator when acting on signals having excessive spectral contents.

A DSP system represented by a function g on digital signals takes as input a discrete image array S(I) that is sampled from a continuous band-limited signal I, and transforms SW into an output discrete image array g(S(I)), which would reconstruct and represent a continuous band-limited signal S*(g(S(I))) per the Nyquist-Shannon sampling theorem. In other words, such a DSP algorithm or system g operating on digital signals implements an effective composite function ƒ=S*g S [symbol] S*∘g∘S, whose domain and range are two spaces of continuous signals that may or may not be the same.

Definition 3. A DSP system represented by a function g on discrete signals is called shift-invariant or translation-invariant, if and only if the composite function S*g S is translation-invariant over the space of band-limited signals whose bandwidth is less than half of the DSP sampling rate.

It can be straightforwardly verified that all of the four functional elements in Definition 1 commute with any translation operator T_{∈x}, δx∈ [symbol] ^{d}, d∈ [symbol] on a continuous signal. It is also clear that any combination of the four functional elements is shift-invariant for continuous signals, because for any pair of functional elements ƒ₁ and ƒ₂, it follows from T_{δx}⁻¹ƒₜ T_{δx}=ƒ₁, T_{δx}⁻¹ƒ₂ T_{δx}=ƒ₂ that

T_{δx}⁻¹(ƒ₁+ƒ₂)T_{δx}=ƒ₁+ƒ₂, (1)

T_{δx}⁻¹(ƒ₁∘ƒ₂)T_{δx}=(T_{δx}⁻¹ƒ₁T_{δx})∘(T_{δx}⁻¹ƒ₂T_{δx})=ƒ₁∘ƒ₂. (2)

Therefore, any analog CNN processing continuous signals is shift-invariant.

In a digital CNN processing discrete signals, the three functional elements 1), 3), and 4) in Definition 1 are still aliasing-free and shift-invariant, because these functional elements do not create any new spectral component. However, this is no longer true for a pointwise nonlinear operation, which often creates new spectral components beyond the Nyquist frequency of the input and output discrete signals. That leads to a fundamental and inherent problem of aliasing and shift variance in digital CNNs which is seemingly impossible to solve, unless all of the nonlinear functions involved are polynomials, when aliasing can be avoided by upsampling and downsampling the signals.

Given a (d∈ [symbol] )-dimensional continuous image I′ with a compact support in spacetime and a finite bandwidth W−ϵ, 0<ϵ<<W, it suffices to sample I′ at the Nyquist rate 2 W into a discrete image I, whose domain in the frequency space, denoted by FDom(I)⊆ [symbol] ^{d}, has a width W in each of the d frequency axes. The set of frequency points on which I assumes a nonzero spectral amplitude is called the support of I in the frequency space, denoted by FSupp(I), which is a subset of FDom(I). Many applications choose to oversample I′ at a higher rate 2uW, u>1, yielding a so-called upsampled discrete image J with an enlarged domain FDom(J)=u FDom(I) in the frequency space, even though the spectral amplitudes of J vanish in the set FDom(J)\FDom(I). Such oversampling serves a purpose of either better spatiotemporal resolution or anti-aliasing in a subsequent operation.

Definition 4. A discrete image I is said to be upsampled into a discrete image J, conversely, J is said to be downsampled into I, when I and J correspond to the same continuous signal, that is, S*(J)=S*(I), but FDom(J)=u FDom(I), with u>1 being an upsampling factor (USF).

A simple application of Fourier analysis asserts that a discrete image I is upsampled into a discrete image J if and only if FSupp(J)=FSupp(I) C FDom(I), while J and I assume identically the same spectral amplitudes on FSupp(I). Operationally, to downsample (upsample) a discrete image I is just to zero out the amplitudes of (fill in zero-valued amplitudes for) its high-frequency spectral components. In particular, downsampling a discrete image as such is obviously aliasing-free and shift-invariant, because it is equivalent to a linear convolution in spacetime. Note that the term “downsampling” without a modifier is reserved for the strict operation of frequency filtering as specified in Definition 4, which is always aliasing-free. This is in contrast to the potentially problematic downsampling done straightforwardly in the spacetime domain without spectrum control, which is always referred to as “AP-downsampling”.

When a polynomial of degree n∈ [symbol] operates on a discrete signal I pointwise in spacetime, even though new frequency components are generated, spectrum overlapping and aliasing can be avoided completely so long as I is upsampled such that FDom(I)>n FSupp(I), because the polynomial cannot broaden the support of I more than n times. After such a polynomial operation, the output signal may be downsampled according to Definition 4 for computational efficiency, with the downsampled signal remaining aliasing-free and shift-invariant.

Intuitively, it seems obvious that a finite digital CNN involving no non-polynomial function can be made aliasing-free and shift-invariant, ideally implementing a continuous CNN comprising corresponding functional elements operating on continuous signals, provided that the digital sampling rates are sufficient to encompass the bandwidths of the continuous signals. Mathematically, this can be proved rigorously as, given any two polynomials g₁ and g₂ on discrete signals, a finite sampling rate exists to operate S and S*, such that, if S*g₁ S and S*g₂ S ideally implement a pair of desired functions on continuous signals, then S*(g)+g₂) S and S*(g₁∘g₂) S=(S*g₁S)∘(S*g₂ S) ideally implement the corresponding composite functions on continuous signals.

Practically, polynomial operations on discrete signals have indeed been rendered aliasing-free by suitable upsampling before and downsampling after [33]. Such method of aliasing elimination has been widely used especially in the field of computational lithography [2, 3], where the tolerance to aliasing-induced shift variance is extremely small, and it is essential to make the image processing aliasing-free for squaring electromagnetic amplitudes into optical intensities or computing a Volterra-Wiener model of photoresist effects [27-29]. Analyses and numerical examples have also been presented in previous publications related to this specification [30,31].

When a digital CNN involves a non-polynomial function, the primitive method of upsampling before and downsampling after is unable to fully resolve the problem of aliasing, because, unlike polynomials, a non-polynomial function broadens the spectrum of a signal endlessly without a definitive frequency cutoff, so that aliasing cannot be completely avoided no matter how many times the input signal is upsampled, although a larger USF does reduce the severity of aliasing-induced problems. The situation is especially bad with a non-analytic function like |z|, \sqrt{z}, or a function having a slowly converging Taylor expansion such as (1+z)⁻¹, (1+z)^{±1/2}, which generate new spectral components at unlimited high frequencies whose amplitudes decay rather slowly.

In order to assess and quantify the severity of shift variance induced by aliasing in a digital CNN or function, it is useful to introduce a rigorous and quantitative measure based on an image norm, for example, the L^{∞} norm as in the following.

Definition 5. Given a digital CNN or function g, an image I as input, and a translation operator T_{δx}, δx∈ [symbol] ^{d}, let ∥·∥_{∞} denote the L^{∞} norm, define a relative shift variance (RSV) as

$$RSV {=}^{def} \frac{2 {‖ {T}_{δ x} g ( I ) - g ( {T}_{δ x} I ) ‖}_{∞}}{{‖ {T}_{δ x} g ( I ) + g ( {T}_{δ x} I ) ‖}_{∞}} , \qquad ( 3 )$$

for a definitive measure of shift variance produced by the CNN or function g.

Aliasing-Free Signal Processing Using Implicitly Defined Functions

Aliasing-induced problems have seemed difficult to overcome in digital CNNs involving a non-polynomial function, especially in neural CNNs that mostly use non-polynomial activations such as the rationals, sigmoid, hyperbolic tangent, ReLU, Swish, max pooling, Softmax, and SoftPool, etc. [9-14], in conjunction with the AP-downsampling which as a signal operation is not spacetime-independent. The problem of aliasing in digital CNNs has remained open for more than thirty years. There is even a commonly held belief that aliasing cannot be rid of completely whenever a non-polynomial function is involved. This belief is overly pessimistic. A fundamental solution to the problem of aliasing is specified below.

The solution is to abandon the dogma of directly and explicitly applying a non-polynomial operation pointwise in spacetime, instead, to specify a desired non-polynomial operation as an implicitly defined function and compute it numerically via an iterative algorithm, which involves only LTI operations and pointwise multiplications, so that upsampling, downsampling, and spectrum control are incorporated to avoid aliasing thoroughly. Given an explicit non-polynomial function g that transforms an input image I to an output image J=g(I), means to define g as an implicit function include specifying an algebraic equation P(I, J, J⁻¹)=0 or prescribing an optimization problem to minimize the norm of a polynomial P(I, J, J⁻¹) [30, 31], where P(·) is a multi-variable polynomial, I is the input image, J and J⁻¹ [symbol] 1/J are the output image and its pointwise reciprocal. It is useful to note that, despite the appearance of J⁻¹ in the defining polynomial P(I, J, J⁻¹), no pointwise division will be ever done to any image during the algorithmic iterations, but algebraic cancellation or compensation will leave only polynomial functions to evaluate.

At the n-th iteration, n∈ [symbol] , the iterative algorithm produces an aliasing-free image Jₙ as the n-th implicit approximant to the desired output J=g(I). With a good iterative algorithm, the n-th implicit approximant Jₙ(·) converges to the function g(·) as n∈ [symbol] increases. In practice, an iterative algorithm is always terminated at a finite n-th iteration with a predetermined n∈ [symbol] , and outputs the image Jₙ(I) as a function of the input I, so that the algorithm realizes a function Jₙ(·) as the n-th implicit approximant to the implicitly defined function g(·). Usually, a larger n∈ [symbol] helps to produce a closer approximant to the original explicit non-polynomial function but entails a higher computational cost. A practical choice of n∈ [symbol] should be a reasonable tradeoff that achieves a satisfiable approximant within an affordable computational cost. It is important to note that any resulted n-th implicit approximant Jₙ(·), ∀∈ [symbol] is always aliasing-free regardless of at which stage the iteration algorithm terminates.

Take the explicit function J(I)=1/I, with I(x)∈(0, 1), ∀x∈ [symbol] ^{d} for an exemplary embodiment. The pointwise division can be defined implicitly as the solution to an algebraic equation P(I, J⁻¹)=J⁻¹−I=0, for which the celebrated Newton's (or Newton-Raphson) method [34, 35] suggests an algorithm of division via iterated multiplications (DVIM) with

J₀= [symbol] , Jₙ₊₁=Jₙ−P(I,Jₙ⁻¹)/P′(Jₙ)=Jₙ+Jₙ( [symbol] −IJₙ)=Jₙ(2 [symbol] −IJₙ), ∀n≥0, (4)

where each iteration involves only linear combinations and pointwise multiplications between images, [symbol] represents a constant image having unit-valued pixels. Let BW(I) be the known bandwidth of I and BW(J) denote a predetermined bandwidth allowance for J. Following the previous analyses, to make each iteration with n≥0 aliasing-free, both I and Jₙ may be upsampled to have a frequency support wider than BW(I)+2 BW(J), then pointwise multiplications and a linear combination are executed to produce a product image Jₙ(2 [symbol] −IJₙ), which is subsequently downsampled to within the bandwidth allowance BW(J). It is clear that spectrum overlapping and aliasing are avoided in each iteration, yielding strictly aliasing-free approximants Jₙ(I), ∀n≥0. Practically, it takes n=6˜10 iterations to obtain a Jₙ(I) such that ∥Jₙ(I)−J(I)∥_{∞}<0.01∥J(I)∥_{∞}.

Another efficient method of DVIM is based on the Goldschmidt iteration [36] in conjunction with the binomial theorem and repeated squaring. Let z∈[ϵ, 2−ϵ], ϵ>0 being a fixed constant. To compute the reciprocal z⁻¹=(1−ζ)⁻¹, ζ [symbol] 1−z∈[ϵ−1, 1−ϵ], one uses the identity

$$\frac{1}{1 - ζ} = \frac{1 + ζ}{1 - {ζ}^{2}} = \frac{( 1 + ζ ) ( 1 + {ζ}^{2} )}{1 - {ζ}^{4}} = … = \frac{{\prod }_{k = 0}^{n - 1} ( 1 + {ζ}^{{2}^{k}} )}{1 - {ζ}^{{2}^{n}}} , ∀ n ∈ ℕ , \qquad ( 5 )$$

to approximate (1−ζ)⁻¹ as Πₖ₌₀ⁿ⁻¹(1+ζ²^{^{k}}) by neglecting ζ²^{ⁿ} in the denominator, which diminishes rapidly once n becomes larger than |log₂ϵ|. Now the multiplication-only approximation (1−ζ)⁻¹≈Πₖ₌₀ⁿ⁻¹(1+ζ²^{^{k}}) can be efficiently computed in a prescribed logarithmic number n∈N of computational steps: allocate computer memory for two variables ξ and Z and initialize them as Z←1 and ξ←ζ, then repeat for n times the computations and refreshments of data in memory as Z←Z(1+ξ) followed by ξ←ξ², finally output the result in Z as an approximant for (1−ζ)⁻¹. When such a DVIM method is used to approximate [J(I)](x)=1/I(x), x∈ [symbol] ^{d}, firstly the image I should be suitably biased and scaled such that I(x)∈[ϵ, 2−ϵ], ∀x∈ [symbol] ^{d}, then the image [symbol] −I is squared repeatedly to compute Jₙ(I)=Πₖ₌₀ⁿ⁻¹[ [symbol] +( [symbol] −I)²^{^{k}}], n≥1, where, during each step of repeated squaring, the image to be squared is 2× upsampled with respect to its bandwidth allowance, then pointwise squared, and finally downsampled to the bandwidth allowance. Take an ϵ≥0.01, then an n=6˜10 guarantees a Jₙ(I) such that ∥Jₙ(I)−J(I)∥_{∞}<0.01∥J(I)∥_{∞}, thanks to the superfast convergence of repeated squaring.

Having an aliasing-free reciprocal function realized, it is straightforward to implement any Wiener-Padé model, that is a rational function WP(I)=p(I)/q(I), by cascading Volterra-Wiener polynomials p(·) and q(·) with the aliasing-free reciprocal function, where p(·) and q(·) are themselves compositions of LTI operations and pointwise multiplications. This provides a complete toolbox to implement or approximate any CNN in a completely aliasing-free fashion, since it has been both proved theoretically [9] and demonstrated numerically [11,12] that the rational functions are already universal and efficient to approximate any CNN to any prescribed accuracy. In principle, any digital CNN involving non-polynomial functions can be realized in a completely aliasing-free fashion, when all non-polynomial functions are approximated by aliasing-free Wiener-Padé functions.

Still, it is theoretically interesting and practically useful to have some other non-polynomial functions defined implicitly and computed iteratively in an aliasing-free fashion, without resorting to a Wiener-Padé approximant. One particularly good example is the ubiquitous sigmoid function sigm(·), which is closely related to the sign function sign(·) [37, 38] as sigm=( [symbol] +sign)/2. The sigmoid function is ubiquitous and almost all-encompassing in neural CNNs because its sharp transition between two constant values is characteristic of many neural activations. Firstly, there is ReLU(z)=z×sigm(z), which becomes the Swish function when sigmoid takes a smooth form sigm(z)=(1+e^{-z})⁻¹), z∈ [symbol] . Then, for max pooling, there is max{z, w}=z+ReLU(w−z). More specifically, for the max pooling operation on an image array (called a tensor in the neural CNN community), pooling in multiple dimensions can be achieved by cascading multiple stages of one-dimensional pooling, while a stride-2 one-dimensional image pooling can be implemented via ReLU as max{I(2i,:), I(2i+1,:)}=I(2i,:) ReLU{I(2i+1,:)−I(2i,:)}, where I represents a multi-dimensional array, 2i and 2i+1 with i∈ [symbol] are two adjacent indices along a specific axis, while “:” indicates the indices along other axes. Therefore, an aliasing-free realization of the sign(·) function can serve as a basis to implement many neural activation functions.

Many iterative algorithms exist to compute sign[I(x)], x∈ [symbol] ^{d} as an implicit function satisfying a characteristic equation [ [symbol] −sign(I)][ [symbol] +sign(I)]=0 [37]. In particular, a Newton iteration J₀=I, Jₙ₊₁=(Jₙ+Jₙ⁻¹)/2, n≥0 for the sign function is combined with the Newton-Raphson division to yield a division-free Newton-Schulz algorithm [37, 38],

$${J}_{0} {=}^{def} I , {J}_{n + 1} {=}^{def} \frac{1}{2} {J}_{n} ( 3 - {J}_{n}^{2} ) , n ⩾ 0 , \qquad ( 6 )$$

which converges to lim_{n→∞}Jₙ(I)=sign(I) when ∥ [symbol] −I²∥_{∞}<1. Such iteration enables a straightforward aliasing-free implementation for sign(·) using upsampling and spectrum control. Specifically, the Newton-Schulz iteration of equation (6) can be adapted to approximate the sign function by executing each iteration step with n≥0 in a spectrum-controlled and aliasing-free fashion, which has Jₙ 3× upsampled with respect to a bandwidth allowance BW(J), then computes the pointwise cubic power of the image in spacetime, finally downsamples the cubic-powered image to produce an Jₙ₊₁, whose spectral components vanish outside the bandwidth allowance BW(J).

For another example, consider the inverse square root function, J=I^{-1/2}, I(x)∈(0, 1), ∀x∈ [symbol] ^{d}. One starts with rewriting the explicit operation J=I^{-1/2} into an implicitly defined function via an algebraic equation P(I, J⁻¹)=J⁻²−I=0, then applies Newton's method of root-finding to derive an iterative formula

$${J}_{0} = , {J}_{n + 1} = {J}_{n} - P ( I , {J}_{n}^{- 1} ) / {P}_{J}^{′} ( {J}_{n} ) = {J}_{n} + \frac{1}{2} {J}_{n} ( - {IJ}_{n}^{2} ) = \frac{1}{2} {J}_{n} ( 3 - {IJ}_{n}^{2} ) , ∀ n ⩾ 0 , \qquad ( 7 )$$

which involves only iterative multiplications and can be made entirely aliasing-free via upsampling, downsampling, and spectrum control. Once an aliasing-free I^{-1/2} is obtained, an aliasing-free I^{1/2}=I×I^{-1/2} is easily computed with just one more step of aliasing-free multiplication.

Numerical examples can illustrate the methods and applications. Consider a Wiener-Padé function WP employed in computational lithography [2, 3, 27-29] to model the photochemical response of a photoresist, transforming an optical image {I(x,y):(x,y)∈ [symbol] ²} into a resist image {J(x,y):(x,y)∈ [symbol] ²}, such that

$$J ( x , y ) = W P [ I ( x , y ) ] {=}^{def} \frac{[ p ( I ) ] ( x , y )}{[ q ( I ) ] ( x , y )} {=}^{def} \frac{( 1 + a ) {\{ [ I * h ] ( x , y ) \}}^{2}}{{I}_{m}^{2} + a {\{ [ I * h ] ( x , y ) \}}^{2}} , ∀ ( x , y ) ∈ {ℝ}^{2} , \qquad ( 8 )$$

where {h(x,y) [symbol] (2πσ²)⁻¹ exp[−(x²+y²)/2σ²]} is a two-dimensional Gaussian kernel meant to simulate the spatial blurring effects due to chemical diffusion, σ>0 and a>0 are constant parameters, Iₘ>0 is the maximum value of the image {I(x,y)}, and the * operator represents a two-dimensional convolution. It is easily seen from equation (8) that the WP function, being rational and a Pad\tilde{e} approximant, characterizes the sigmoid curve-like response of a photoresist, which suppresses small [I*h] (x,y) values further down toward 0 and saturates toward the maximum value 1 for large [I*h] (x,y) values.

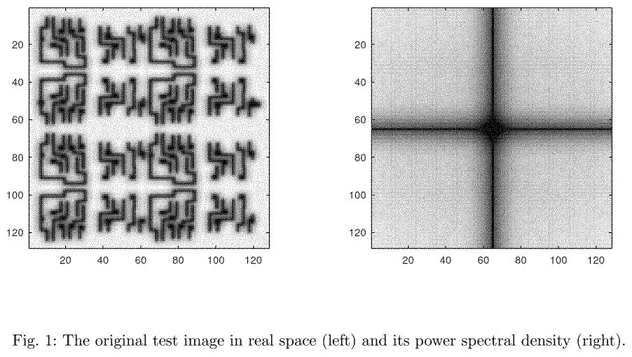

An optical image from a computational lithography simulator is chosen as a test image, which is a 128×128 two-dimensional (2D) array of discrete samples from a band-limited optical intensity distribution, with the spacing between adjacent pixels, known as the grid size, being 50 nm in both the horizontal and the vertical directions. The test image is shown in FIG. 1 (left), where the grayscale from dark to bright represents intensity values from nearly 0 to almost 1. FIG. 1 (right) shows the power spectral density of the test image in log scale, displaying the logarithm of the absolute value squared of the amplitudes of the spectral components, where the grayscale from dark to bright represents low to high numerical values. From FIG. 1 (right), it can be clearly seen that the test image has been sampled at a DSP sampling rate slightly higher than the Nyquist rate, such that its spectral image has a small margin with vanishing amplitudes for the highest frequency components. The same grayscales will be used in the following for images in the 2D real space and the spectral domain respectively, without repeating how they should be interpreted. Such an optical image is band-limited by fundamental physics, because the light wave has a finite wavelength and the projection lens has a finite numerical aperture [2,3], so it can be properly sampled into a discrete 2D array without aliasing.

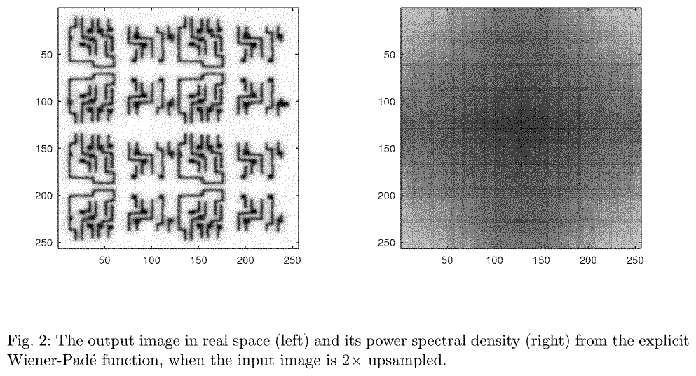

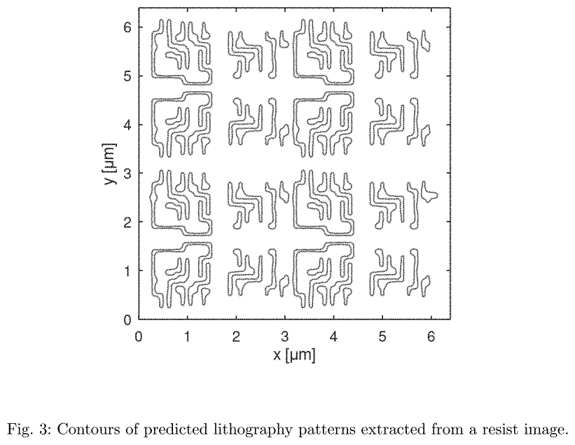

By contrast, the photoresist process is highly nonlinear and generates a lot of high-frequency components beyond the Nyquist frequency of the optical image. When a Wiener-Pad\tilde{e} function of equation (8) is employed to model a photoresist process, both polynomials p(I) and q(I) can be make perfectly aliasing-free by upsampling the image I before pointwise squaring. Unfortunately, the division operation in WP=p(I)/q(I), if directly executed explicitly, makes it difficult to avoid aliasing, no matter how the input image is upsampled. As shown in FIG. 2 (left) and (right), even with I(x,y) 2× upsampled, the resist image predicted by the WP function with σ=7.5 nm, a=2.5², Iₘ=1.0 still suffers from spectrum overlapping and aliasing, and produces an RSV=2.54×10⁻³ under a typical shift of (δx, δy)=(0.3, 0.3) pixel, which is already a significant source of error in computational lithography, as an error on the order of 10⁻³ in images could lead to an offset of a few tenths of nm in edge placements of simulated lithography patterns. Such lithography patterns are usually represented by contour lines as a level set of a continuous resist image at a prescribed threshold. FIG. 3 shows contour lines at the threshold level 0.45 from said resist image.

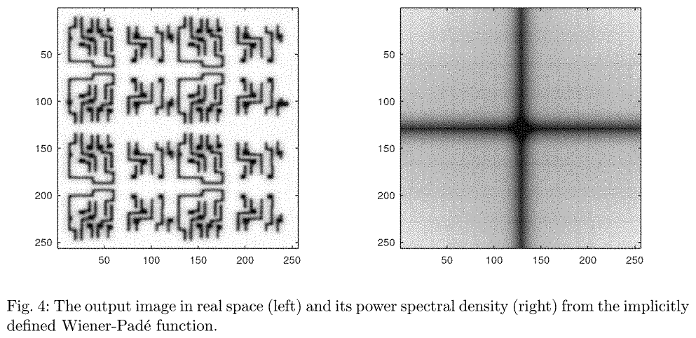

To avoid aliasing and shift variance, the Wiener-Pad\tilde{e} function of equation (8) can be implemented implicitly as J(I)=p(I)K(I), K(I)=1/q(I), with the reciprocal function realized via the Newton-Raphson division algorithm. A concrete numerical experiment uses the test image of FIG. 1 as an input image I, with the bandwidth allowance for the output image being set to BW(J)=2 BW(I), other Wiener-Pad\tilde{e} parameters being chosen as σ=7.5 nm, a=2.5², Iₘ=1.0, and the Newton-Raphson division being terminated at the 6th iteration, such that the 6th implicit approximant K₆ is obtained and output, which approximates the reciprocal of q(I) very well, with ∥ [symbol] −q(I)K₆∥_{∞}<5×10⁻³. The output image and its log-scaled power spectral density are shown in FIG. 4 (left) and (right) respectively. Remarkably, under any shift of (δx, δy), the shift variance detector always reports an RSV<5×10⁻¹⁵, on a par with numerical rounding errors, confirming the absence of aliasing-induced shift variance.

For a more comprehensive test and comparison, the above-described explicit Wiener-Padé (eWP) and implicit Wiener-Padé (iWP) functions have been run repeatedly under six combinations of spatial shifts, with δx=0.3, 0.5, 0.7 and δy=0.3, 0.4 in unit of image grid. The eWP and the iWP functions have the same bandwidth allowance BW(J)=2 BW(I) for their output images. Octave functions and test scripts have been executed on a Windows 11-operated Dell Precision 7540 computer equipped with an Intel® Core™ i7-9850 CPU @2.60 GHz and 23.4 GB worth of available physical memory. Under any of the tested spatial shifts (δx, δy), the iWP function always converges within 6 Newton-Raphson iterations to produce a satisfying approximant with an L^{∞} error less than 5×10⁻³. Table 1 records the RSV values and CPU times associated with the eWP and iWP functions under the combinations of spatial shifts, where the eWP and iWP times refer to the CPU times spent by a shift-variance detecting program when running the explicit and implicit Wiener-Padé functions respectively. It is seen that eWP runs faster but suffers from significant RSVs that average to 3.82×10⁻³, while iWP incurs a runtime overhead about 8× but completely free of aliasing-induced shift variance.

TABLE 1
RSV values and runtime costs of the eWP and iWP functions under combinations
of spatial shifts (δx, δy) in unit of image grid.

| (δx, δy) | (0.3, 0.3) | (0.5, 0.3) | (0.7, 0.3) | (0.3, 0.4) | (0.5, 0.4) | (0.7, 0.4) |
|---|---|---|---|---|---|---|
| eWP RSV | 5.16 × 10⁻³ | 2.45 × 10⁻³ | 4.58 × 10⁻³ | 4.91 × 10⁻³ | 1.46 × 10⁻³ | 4.34 × 10⁻³ |
| eWP time | 1.57 sec | 1.58 sec | 1.58 sec | 1.58 sec | 1.57 sec | 1.58 sec |
| iWP RSV | 4.03 × 10⁻¹⁵ | 4.17 × 10⁻¹⁵ | 3.98 × 10⁻¹⁵ | 4.06 × 10⁻¹⁵ | 4.62 × 10⁻¹⁵ | 3.69 × 10⁻¹⁵ |
| iWP time | 12.62 sec | 12.74 sec | 12.74 sec | 12.80 sec | 12.69 sec | 12.71 sec |

Both the mathematical analyses and the numerical examples have demonstrated that any CNN can be rendered aliasing-free by implementing non-polynomial operations as implicitly defined functions, which are computed via iterations that involve only polynomials, with all polynomial functions made aliasing-free by upsampling images before pointwise multiplications. This resolves the long-standing open problem of aliasing in CNNs, and establishes that non-polynomials do not necessarily entail unavoidable aliasing, although the algorithmic iterations computing them as implicitly defined functions incur a factor of 6˜10 in computational overhead. Practically, such computational cost may be a due price to pay in critical applications that do not tolerate aliasing. Alternatively, the cost of iterative multiplications may be absorbed by hardware circuitry in future technology of hardware acceleration using graphics processing units (CPUs), DSP chips, or the so-called tensor processing units (TPUs). Indeed, in modern computer systems, it is exactly hardware acceleration that makes the operation of explicit division almost as fast as a multiplication.

### Symmetrizing Neural CNNs for Shift Invariance

In many applications, especially those using neural CNNs, discrete images are treated as primitive signals, no band-limited continuous images are associated and need to be recovered. The spacetime coordinate is limited to a subset of [symbol] ^{d}, d∈ [symbol] , and it suffices to make a CNN shift-invariant under integral shifts T_{Δx}, Δx∈ [symbol] ^{d}, or equivalently, under each unit shift T_{1,i} along the i-th spacetime axis, ∀i∈[1, d]. Specifically, ∀i∈[1, d], ∀x∈ [symbol] ^{d}, let xᵢ denote the i-th coordinate component of x, such that x=(x₁, . . . , xᵢ, . . . , x_{d}). Then [T_{1,i}I] (x₁, . . . , xᵢ, . . . , x_{d}) [symbol] I(x₁, . . . , xᵢ+1, . . . , x_{d)}, ∀i∈[1, d], for any image {I(x₁, . . . , xᵢ, . . . , x_{d})}. It is clear that T_{Δx}=Πᵢ₌₁^{d}T_{1,i}^{Δx}^{ᵢ} holds true for any Δx=(Δx₁, . . . , Δxᵢ, . . . , Δx_{d})∈ [symbol] ^{d}.

A neural CNN often changes the sampling rates of images via upsampling or AP-downsampling. Let the unit pixels indexed by an x=(x₁, . . . , xᵢ, . . . , x_{d})∈ [symbol] ^{d} be associated with an image at the highest sampling rate, with respect to which, an AP-downsampled image consists of stride pixels that, although still indexed by a y=(y₁, . . . , yᵢ, . . . , y_{d})∈ [symbol] ^{d}, actually correspond to a position x=sy [symbol] (s₁y₁, . . . , sᵢyᵢ, . . . , s_{d}y_{d}) in spacetime filled with unit pixels, where s=(s₁, . . . , sᵢ, . . . , s_{d}) [symbol] [symbol] ^{d}, sᵢ≥1, ∀i∈[1, d] is called the vector of strides of an AP-downsampling step, or a combination of AP-downsampling steps, as well as the AP-downsampled images.

Definition 6. For any given vector of strides s=(sᵢ, . . . , sᵢ, . . . , s_{d})∈ [symbol] ^{d}, a stride-s MaxPool2D operation transforms any input image {I(x):x∈ [symbol] ^{d}} into a smaller output image {J(y):y∈ [symbol] ^{d}}, such that, ∀y∈ [symbol] ^{d}, the image J(·) assumes a value J(y)=max{I(sy+r):r∈ [symbol] ^{d}, 0≤r<s} at the pixel indexed by y, where ∀r=(r₁, . . . , rᵢ, . . . , r_{d})∈ [symbol] ^{d}, the vectorial inequality 0≤r<s means that 0≤rᵢ<sₜ, ∀i∈[1, d].

Definition 7. For any given vector of strides s∈ [symbol] ^{d}, any vector r∈ [symbol] ^{d} of shifts, 0≤r<s, and any image {I(x):x∈ [symbol] ^{d}}, a related image {Iᵣ (y):y∈ [symbol] ^{d}} is called the r-th stride-s subimage of I(·), or the stride-s subimage of I(·) associated with the shift r, if ∀y∈ [symbol] , the image Iᵣ(·) assumes a value Iᵣ(y)=I(sy+r) at the pixel indexed by y. A stride-s DirectDownSample operation outputs the 0-th stride-s subimage I₀(·) of any input image I(·).

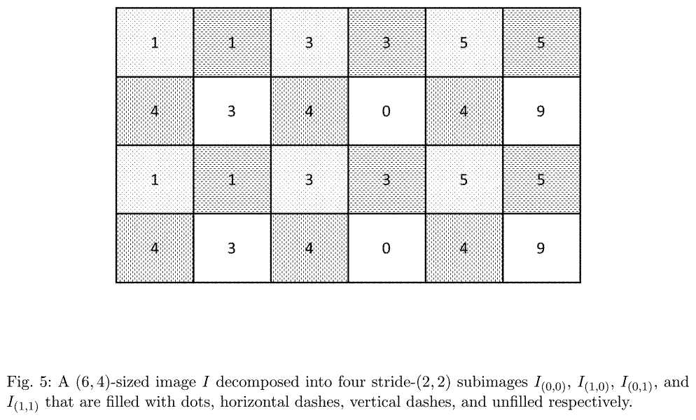

FIG. 5 illustrates a (6, 4)-sized image I decomposed into four stride-(2, 2) subimages I_{(0,0)}, I_{(1,0)}, I_{(0,1)}, and I_{(1,1)} that are filled with dots, horizontal dashes, vertical dashes, and unfilled respectively. A stride-(2, 2) DirectDownSample operation taking I as input produces the subimage I_{(0,0)} as output, which consists of the dot-filled pixels.

Let g be spacetime-independent and represent either a linear convolution or a pointwise nonlinear operation on an image in a spacetime filled with unit pixels indexed by [symbol] ^{d}. It is obvious that g preserves the sampling rate from the input to the output images, and is invariant under any integral shifts, namely, gT_{Δx}=T_{Δx}g, ∀Δx∈ [symbol] ^{d}. Any upsampling operation by itself cannot induce shift-variance either. Thus, an AP-downsampling operation in a neural CNN, which is spacetime-dependent and reduces the sampling rate, is the only possible culprit for shift variance. Nevertheless, it is usually the case that such AP-downsampling is still stride-invariant.

Definition 8. Let s∈ [symbol] ^{d} be a vector of strides, and gₛ be an AP-downsampling function. Such gₛ is called s stride-invariant, or just stride-invariant in short, if another vector of strides r=(r₁, . . . , rᵢ, . . . , r_{d})∈ [symbol] ^{d} exists in accordance with s and gₛ, such that gₛTₛ=Tᵣgₛ.

Note that gₛTₛ=Tᵣgₛ is an identity between two operators, which holds if and only if their effects on any image are always the same, namely, gₛ (TₛI)=Tᵣgₛ(I) holds for any image I. For instance, in the popular TensorFlow or PyTorch platform, an image is conventionally a two-dimensional array having a height and a width axes, the vector of strides s=(2, 2) is often used, and the stride(2, 2) MaxPool2D is a typical AP-downsampling function. The function g_{(2,2)}=MaxPool2D is (2, 2) stride-invariant, because a forward shift of the input by s=(2, 2) is compensated by a backward shift of the output by r=(1, 1), that is, g_{(2,2)}T_{(2,2)}=T_{(1,1)}g_{(2,2)}.

Without loss of generality, all AP-downsampling operators are assumed to be stride-invariant in this specification. For any neural CNN of interest, if s∈ [symbol] is the vector of strides of an AP-downsampled image having the largest-sized stride pixels with respect to the smallest-sized pixels of all images in the network, then the neural CNN is s stride-invariant. The reason is that any vector r∈ [symbol] ^{d} of strides associated with any AP-downsampling operator in the network must satisfy r|s, meaning rᵢ|sᵢ, ∀i∈[1,d], that is, any rᵢ is an integer factor of sᵢ, ∀i∈[1, d]. Therefore, any AP-downsampling operator being r stride-invariant is necessarily s stride-invariant because of r|s.

A neural CNN represented by gₛ being s∈ [symbol] ^{d} stride-invariant means that the composite operator T_{Δx}⁻¹gₛT_{Δx} as a function of Δx∈ [symbol] ^{d} is s-periodic, namely, T_{Δx+sy}⁻¹gₛT_{Δx+sy}=T_{Δx}⁻¹gₛT_{Δx} holds ∀Δx∈ [symbol] ^{d}, ∀y∈ [symbol] ^{d}, with sy [symbol] (s₁y₁, . . . , sᵢyᵢ, . . . , s_{d}y_{d}). Hence, for any input image I(x), there can be at most Πᵢ₌₁^{d}sᵢ variations of output images J(y)=gₛ[I(x)] under all of the possible integral shifts of the images. The product Πᵢ₌₁^{d}sᵢ is called the volume of the vector s=(s₁, . . . , sᵢ, . . . , s_{d})∈ [symbol] ^{d}, which is denoted by vol(s). The finite number of variations permits straightforward and efficient methods for canceling shift variances in a neural CNN by symmetrizing the network.

One method of symmetrization is mostly brute-force and called symmetric summation, which wraps an s∈ [symbol] ^{d} stride-invariant neural CNN gₛ within a for-loop that traverses all of the integral shifts S [symbol] {r∈ [symbol] ^{d}: 0≤r<s} and computes a symmetrized operator g′=vol(s)⁻¹ Σ_{r∈S}Tᵣ⁻¹gₛTᵣ, which is evidently invariant under any integral shifts. Clearly, this method of symmetric summation could incur a steep computational cost when the volume of the vector of strides is large. On the other hand, when vol(s) is small, practical numerical tests have observed quite mild computational costs. This method seems to be suitable for symmetrizing a subsystem or module that is s stride-invariant for a vector s∈ [symbol] ^{d} with a small vol(s).

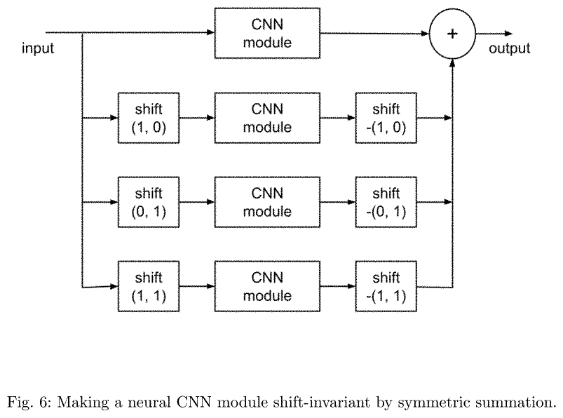

FIG. 6 is a block diagram showing symmetric summation for a neural CNN module that is (2, 2) stride-invariant, where the CNN module is invoked four times with all of the different stride shifts applied forward before it and backward after it, so that the results sum into a shift-invariant output. Such construct has been tested in TensorFlow to symmetrize a single-stage autoencoder comprising a stride-(2, 2) DirectDownSample layer and a stride-(2, 2) transposed convolution layer. Numerical tests have confirmed the expected shift-invariance, and observed negligible runtime increase over the non-symmetrized CNN module, when the construct is employed for the innermost autoencoder layers.

Another method of symmetrization, called optimal image positioning, uses a preprocessor to examine input images before sending them to an s∈ [symbol] ^{d} stride-invariant neural CNN, so to identify an optimal shift for each input image to be optimally positioned. Taking inspiration from the scheme of adaptive polyphase sampling to make each downsampling operation shift-invariant [39], the method of optimal image positioning improves to place a single preprocessor before an entire neural CNN that is known to be s∈ [symbol] ^{d} stride-invariant, so to make the whole network shift-invariant while incurring a network complexity-independent (except for the s vector of strides) computational cost, which is often negligible when the neural CNN is computation-intensive. Advantageously, the method shifts and orders images in a spacetime axis-separated fashion to reduce the computational complexity. Also importantly, the method employs a spectrum-based order for comparison among images of the same shape, which avoids collision and ambiguity, making the order total.

Let a total order ≤ be chosen for the set [symbol] ^{d} of pixel indices, such that ∀x, y∈ [symbol] ^{d}, either x≤y is true and y≤x is false, or y≤x is true and x≤y is false, otherwise, x≤y and y≤x are both true if and only if x=y. One choice of such a total order is the lexicographic order, which determines the order between an x=(x₁, x₂, . . . , x_{d})∈ [symbol] ^{d} and a y=(y₁, y₂, . . . , y_{d})∈ [symbol] ^{d} by firstly checking which of x₁ and y₁ is smaller, then comparing x₂ and y₂ in case of x₁=y₁, so on and so forth. There are many other choices of a total order in [symbol] ^{d} that serve the same purpose.

Definition 9. Given two images of the same shape, {I₁(x):x∈ [symbol] ^{d}}} and {I₂(x):x∈ [symbol] ^{d}}, d∈ [symbol] , which are Fourier transformed into {J₁(k)= [symbol] [I₁](k):k∈ [symbol] ^{d}} and {J₂(k)= [symbol] [I₂](k):k∈ [symbol] ^{d}}, let k*∈ [symbol] ^{d} be the smallest index such that |J₁(k*)|≠|J₂(k*)|, then I₁ is said to be a greater image than I₂ if |J₁(k*)|>|J₂(k*)|, denoted as I₁ [symbol] I₂, conversely, I₂ [symbol] I₁ if |J₂(k*)|>|J₁(k*)|. Both I₁ [symbol] I₂ and I₂ [symbol] I₁ are considered true, when no k*∈ [symbol] ^{d} exists as specified.

Clearly, the relation [symbol] in Definition 9 establishes a partial order among the images of the same shape. The partial order is made invariant under shifts of images in spacetime by comparing the absolute values of their spectral components between two images. That it checks many to all of the spectral components makes it rather effective in avoiding collision or ambiguity, which occurs, for example, when two different images happen to have the same zero-frequency components.

If two images have all of their spectral components equal in absolute values, then it is highly likely that the two images are substantially the same up to a shift in spacetime. Specifically, using the theory of deterministic phase retrieval [40], two spectral images can be generated from a single image in spacetime to associate the single image with twice-numbered spectral pixels of absolute values, so that a total order [symbol] can be defined by comparing the twice-numbered spectral pixels, because I₁ [symbol] I₂ and I₂ [symbol] I₁ hold simultaneously if and only if the two images I₁ and I₂ are identical up to a shift in spacetime. Practically, in consideration of floating-point rounding errors and other sources of noise, it may be advantageous to set a small-numbered margin of clearance when comparing the absolute values of spectral components between two images. Which is larger between two spectral absolute values is determined only if the difference exceeds the margin of clearance. Otherwise, the two spectral absolute values are substantially equal.

Definition 10. Let s∈ [symbol] ^{d} be a given vector of strides, {I(x):x∈ [symbol] ^{d}} any image, and [symbol] a chosen partial order among the stride-s subimages. Let r*∈ [symbol] ^{d}, 0≤r*<s be such that the subimage I_{r*} is maximal among the subimages of I, namely, I_{r*} [symbol] Iᵣ for all r∈ [symbol] ^{d}, 0≤r<s. Such r* is called an optimal shift to have the image I optimally positioned as T_{r*}I, which would go through the DirectDownSample function to produce I_{r*} as the output.

For an intuitive example, refer to FIG. 5 again and envision the four stride-(2, 2) subimages being compared. Having a smaller absolute value for the zero-frequency component, the pixel-dotted and pixel-horizontal-dashed subimages are smaller than the pixel-vertical-dashed and pixel-unfilled ones. Despite sharing the same zero-frequency component, the pixel-unfilled subimage is larger than the pixel-vertical-dashed one because of a larger absolute value for the first non-zero frequency component in the horizontal direction. For the example (6, 4)-sized image I, the optimal shift is r*=(1, 1), with which the pixel-unfilled maximal subimage becomes the first subimage in T_{r*}I, and would be the output of DirectDownSample(T_{r*}I).

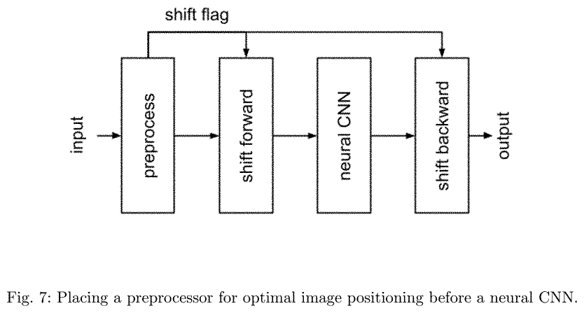

Now the method of optimal image positioning can be described rather precisely and concisely. To achieve shift-invariance with a neural CNN gₛ that is known to be s∈ [symbol] ^{d} stride-invariant, the method employs and places a preprocessor in front of the neural CNN as shown in FIG. 7, which finds an optimal shift for each input image by Fourier-analyzing its stride-s∈ [symbol] ^{d} subimages and comparing their spectral absolute values to determine a partial order [symbol] as specified in Definition 9, then passes the input image on and feeds forward a shift flag, which informs spacetime translation operators to shift forward and backward images respectively before and after the neural CNN.

For any input image I, the preprocessor and the shift forward module in FIG. 7 make sure that it is always the optimally positioned T_{r*}I being fed to the neural CNN gₛ, producing the same result gₛ[T_{r*}I] regardless of how the image I is positioned in spacetime. This guarantees shift-invariance of the whole system from the input to the output in FIG. 7. A note is in order on the operation of the shift backward module, upon receiving the shift flag informing the value of r*. The module simply applies a T_{-r*} operator to the output image if it is at exactly the same pixel resolution as the input. The module applies a T_{-r*u} operator to the output image if it is upsampled by a vector of factors u=(u₁, u₂, . . . , u_{d})∈ [symbol] ^{d} over the input. Otherwise, if the output image is downsampled by a vector of factors u∈ [symbol] ^{d} with respect to the input, then the backward shift module firstly upsamples the image by the vector of factors u, then applies a T_{-r*} operator, and finally downsamples the image by the vector of factors u, with both the upsampling and the downsampling operations done in an aliasing-free fashion as prescribed in Definition 4.

In practice, finding the optimal shift r*=(r*₁, r*₂, . . . , r*_{d}) can be done in an axis-separated fashion to reduce the computational complexity, that is, firstly processing the first spacetime axis, determining r*₁∈[0, s₁) associated with the maximal subimage I_{(r*}_{₁}_{, 0, . . . , 0)} by Fourier-analyzing the stride-(s₁, 1, . . . , 1) subimages of I, then processing the second spacetime axis for the image I_{(r*}_{₁}_{, 0, . . . , 0)}, determining r*₂∈[0, s₂) associated with the maximal subimage I_{(r*}_{₁}_{, r*}_{₂}_{, . . . , 0)} by Fourier-analyzing the stride-(1, s₂, . . . , 1) subimages of I_{r*}_{₁}_{, 0, . . . , 0)}, so on and so forth, until all of the dϵ [symbol] spacetime axes have been processed and the whole vector r*=(r*₁, r*₂, . . . , r*_{d}) is determined for the optimal shift of the image I.

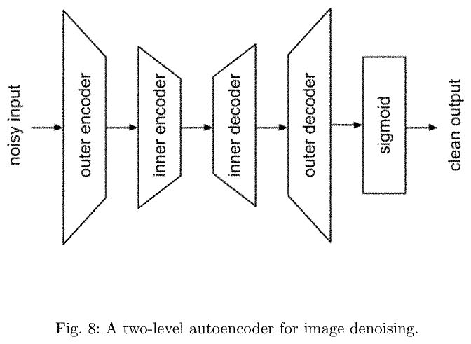

An exemplary embodiment of autoencoder-based image denoising in TensorFlow Keras [41] is adapted and extended to showcase the power of neural CNNs in image processing and (re)generations, demonstrate the fundamental problem of shift variance in neural CNNs, and validate its complete solution by the methods of symmetrization. A conceptual block diagram of the neural CNN is shown in FIG. 8, which is an image denoiser comprising two levels of autoencoder, an inner level and an outer level, each autoencoder itself consisting of an encoder realized by a stride-(2, 2) convolution layer with the Swish activation followed by a stride-(2, 2) MaxPool2D layer, and a decoder realized by a stride-(2, 2) transposed convolution layer with the Swish activation.

The convolution layers are custom-implemented to be circular shift-invariant, as adapted from the example in [42]. Also custom-implemented are the CircMaxPool2D and DirectDownSample functions to ensure circular shift invariance. Further developed are an OptimalShiftPrep2D function for finding optimal shifts, an OptimalShiftFront2D and an OptimalShiftBack2D functions for optimal image positioning, together with utility functions for shifting images and detecting shift variances, all of which are written in TensorFlow Keras and made available in GitHub [32].

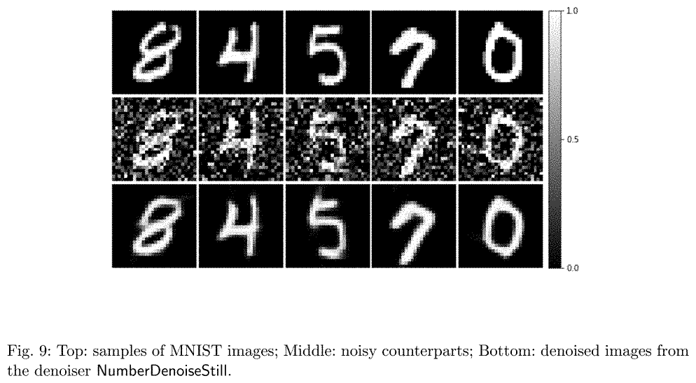

The MNIST database [43] is used to test the autoencoder denoiser and shift variance, which contains 60,000 examples for training and 10,000 examples for test, each being a 28×28 sized image of a handwritten digit. The images are converted to be float32-valued and normalized to have all pixels valued in the interval [0, 1]. Noisy image data are generated by superimposing 0.4×numpy.random.normal(loc=0.0, scale=1.0, size=(28, 28)) to each image, then clipping the pixel values to within the interval [0, 1]. In FIG. 9, the top row shows some samples of MNIST images and the middle row displays their noisy counterparts.

The benchmark denoiser, called NumberDenoiseStill, is an implementation that follows the diagram of FIG. 8 literally, with each encoder consisting of a stride-(2, 2) CircConv2D layer with the Swish activation followed by a stride-(2, 2) CircMaxPool2D layer. Using the Adam optimizer and the MeanSquaredError as loss, the neural CNN is firstly trained for 10 epochs with the original 60,000 training images serving as both the input and the output, so the network learns to encode the clean handwritten digits when the MeanSquaredError decreases to 0.00168 for training and 0.00140 for validation. Then the training continues for another 20 epochs with the input being switched to the noise-corrupted images and the output being the original noise-free images. The MeanSquaredError initially jumps to 0.0111 for training and 0.00985 for validation, but gradually decreases to 0.00764 for training and 0.00765 for validation at the end.

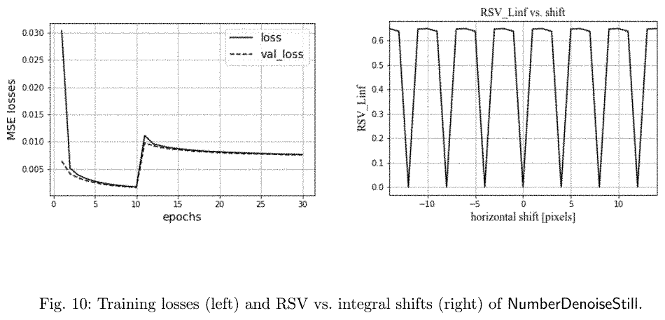

FIG. 10 (left) plots the history of the 30 epochs of training in total, with the training loss shown in the solid line and the validation loss shown in the dashed line, which indicate that NumberDenoiseStill converges well after 30 epochs of training. Validation using the 10,000 test images confirms that the denoiser has learned how to remove the noise and recover the original images with high fidelity, as shown visually by the samples in FIG. 9 bottom row. For a more quantitative assessment, both the original test images and the denoised test images are fed to a pretrained number reader that recognizes and maps each handwritten digit to its intended number 0˜9. Both sets of images achieve the same level of accuracy 93%, giving confidence that the noisy images have been faithfully restored, despite the severe noise corruption. In terms of runtime, each of the 30 epochs takes about exactly the same time of 132 sec, costing 66.0 min in total.

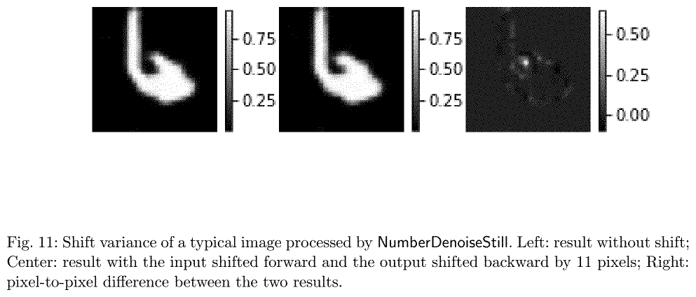

The trained NumberDenoiseStill is then tested for shift variance during inference, using the 10,000 noisy test data as inputs, having the input images undergone horizontal shifts from −14 pixels to +14 pixels and the output images shifted backward accordingly. The denoised results undergoing forward and backward shifts are compared with those of no shift, and the RSV of Definition 5 is computed, which reports the maximum pixel-to-pixel difference between images. For each integral shift, the largest RSV among all of the test images is recorded as RSV_Linf. FIG. 10 (right) plots the value of RSV_Linf against the 29 integral shifts, which exposes an extremely large shift variance oscillating with a period of 4 pixels. FIG. 11 shows the significant shift variance of one image undergoing an integral shift of 11 pixels, where the pixel-to-pixel difference can reach as high as 0.65. The significant shift variance may be attributed to the AP-downsampling compounded by the high nonlinearity of the neural CNN. The observed period of 4 in FIG. 10 (right) is expected, as NumberDenoiseStill has two layers of stride-(2, 2) downsampling, making it (4, 4) stride-invariant. The inference test runs much faster, with each iteration of a shift taking about 8.29 sec, costing 240 sec in total for the 29 shifts.

To solve the problem of shift variance, NumberDenoiseStill is modified to create NumberDenoiseInvar by replacing the layer CircMaxPool2D with DirectDownSample and placing an OptimalShiftPrep2D layer in front to determine the optimal shift for each input image, and feed forward a shift flag to an OptimalShiftFront2D and an OptimalShiftBack2D layers located before and after the modified CNN autoencoder, which always receives an optimally positioned input image and produces a shift-invariant output image.

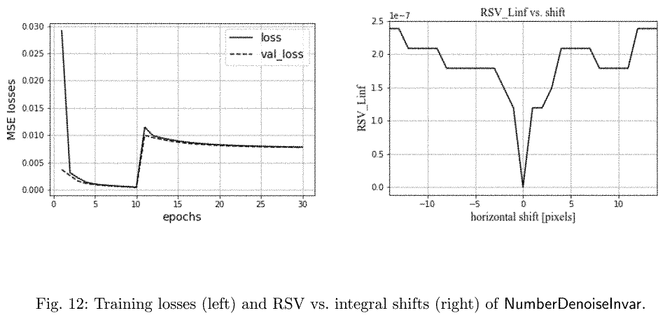

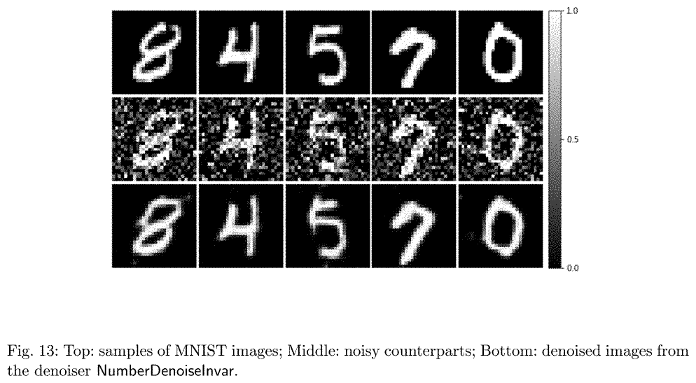

The NumberDenoiseInvar denoiser is trained using the same data sets with the same strategy, achieving MeanSquaredError losses of 0.000493 for training and 0.000437 for validation by the end of the first 10 epochs, then seeing jumped values of 0.0115 for training and 0.0100 for validation at the 11th epoch, and reducing the losses gradually to 0.00784 for training and 0.00776 for validation by the end of all 30 epochs. FIG. 12 (left) shows the learning curves. When subject to an inference test using the same 10,000 noisy test images, the trained NumberDenoiseInvar produces well denoised images, as confirmed quantitatively by the same 93% recognition accuracy when the denoised images are fed to the same number reader. FIG. 13 shows some visual examples of the NumberDenoiseInvar denoiser in action.

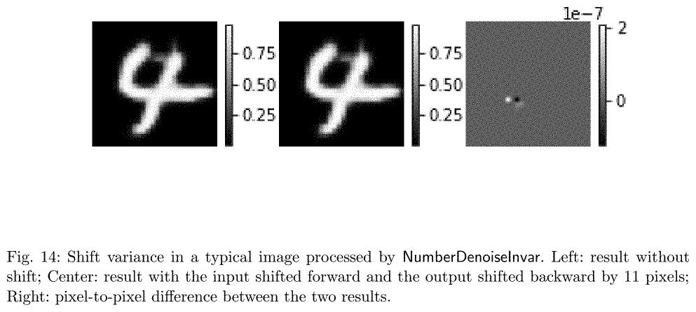

FIG. 12 (right) shows the conspicuous absence of shift variance in NumberDenoiseInvar, so does FIG. 14 for an image experiencing the largest variance under a shift of 11 pixels, both of which report RSV values below 2.5×10⁻⁷, that are on a par with the numerical noise floor of float32, proclaiming the shift-invariance of NumberDenoiseInvar. In terms of runtime, each of the 30 training epochs for NumberDenoiseInvar takes about exactly the same time of 119 sec, costing 59.3 min in total. The inference test for NumberDenoiseInvar also runs much faster, with each iteration of a shift taking about 8.52 sec, costing 247 sec in total for the 29 shifts. The training runs 10.2% faster while the inference runs 2.92% slower for NumberDenoiseInvar than for NumberDenoiseStill. These observations are consistent with the theoretical expectation that spectrum-based ordering and optimal image positioning should entail minimal computational cost, which becomes negligible when the neural CNN itself involves intensive computations.

Interestingly, a hybrid version of NumberDenoiseInvar has been tested using the symmetric summation of FIG. 6 to symmetrize the (2, 2) stride-invariant construct of the inner encoder and the inner decoder in FIG. 8, in conjunction with stride-(2, 2) optimal image positioning to symmetrize the outer-level autoencoder, so to render the whole system shift-invariant. Numerical results have confirmed this hybrid version's excellent performances in network training and denoising inference, as well as complete shift-invariance, on a par with the previous NumberDenoiseInvar. In terms of runtime, the hybrid version takes 139 sec per training epoch and 9.57 sec per integral shift during inference test. The increase in runtime is rather modest, being a far cry from the multitude of added computations by the symmetric summation. Such a favorable runtime behavior may be attributed to either that the inner layers are not the computational bottleneck or that the computation is limited by data access instead of arithmetic throughput.

Besides neural CNNs, it is obvious that general CNNs including the Wiener-Padé CNNs can benefit from the methods of symmetric summation and optimal image positioning, and become shift-invariant under integral shifts. Furthermore, the method of optimal image positioning can be extended to make any general CNN shift-invariant under an arbitrary fractional shift, namely, an arbitrary shift by a fraction of the unit pixel. In one exemplary embodiment, the system of FIG. 7 has a size of unit pixels fixed and determined by the neural CNN module or a general CNN module in its stead, while each of the three modules including the preprocessor, the shift forward, and the shift backward is extended by firstly upsampling its input image by a USF u∈ [symbol] , then applying its designated function on the upsampled image consisting of (1/u)-unit-pixel-sized subpixels, and finally downsampling the resulted image output from the designated function by the factor u and exporting the downsampled image as the output of the extended module. Then the system of FIG. 7 becomes shift-invariant under any shift by a fraction r/u [symbol] (r₁/u, r₂/u, . . . , r_{d}/u) of the unit pixel for any r [symbol] (r₁, r₂, . . . , r_{d})∈ [symbol] ^{d}.

Specifically, let the unit pixel in the CNN module correspond to a vector Δx∈ [symbol] ^{d} of physical dimensions. Namely, any discrete image consisting of unit pixels represents a continuous distribution in a spacetime [symbol] ^{d} being sampled on lattice points defined by a multi-dimensional grid with a vector of spacings Δx [symbol] (Δx₁, Δx₂, . . . , Δxₙ)∈ [symbol] ^{d}. Let the original input image have a shape n [symbol] (n₁, n₂, . . . , n_{d})∈ [symbol] ^{d} and represented by an (n₁×n₂× . . . ×n_{d})-sized multi-dimensional data array, or just called an array in short. To make the system of FIG. 7 shift-invariant under any shift by a fraction r/u of the unit pixel, with r [symbol] (r₁, r₂, . . . , r_{d})∈ [symbol] ^{d} and u∈ [symbol] , the extended preprocessor firstly upsamples the input image by a USF=u to obtain an upsampled image with a shape un [symbol] (un₁, un₂, . . . , un_{d}) and subpixels measuring Δx/u [symbol] (Δx₁/u, Δx₂/u, . . . , Δxₙ/u)∈ [symbol] ^{d} in physical dimensions; then the extended preprocessor applies a spacetime pointwise nonlinear function (such as replacing the value of each spacetime subpixel by the u-th power of said value, or by a p-th root of said value with p≥3 being any odd integer, by way of examples and by no way of limitations) to obtain a spectrum-broadened image, without being concerned with spectrum overlapping and aliasing; next the extended preprocessor runs an optimal image positioning procedure with respect to the spectrum-broadened image and determines an integer-valued optimal shift r* [symbol] (r*₁, r*₂, . . . , r*_{d})∈ [symbol] ^{d} in units of the subpixel, which is equivalent to a fraction r*/u [symbol] (r*₁/u, r*₂u, . . . , r*_{d}/u)∈ [symbol] ^{d} of the unit pixel; finally the extended preprocessor forwards the original input image and exports the optimal shift r* as a shift flag.

More specifically, in one exemplary embodiment of an optimal image positioning procedure with respect to a given image I (such as the above-mentioned spectrum-broadened image) with a shape un=(un₁, un₂, . . . , un_{d}), u∈ [symbol] , n∈ [symbol] ^{d}, it is advantageous to employ an axis-separated strategy, which firstly works on the image I along the first spacetime axis by examining its stride-(u, 1, . . . , 1) subimages listed as {I₍ᵣ_{₁}_{, 0, . . . , 0)}:r₁∈[0, u)}, each of which is (n₁, un₂, . . . , un_{d})-shaped. All of the u subimages are Fourier-transformed and compared according to a predetermined partial order [symbol] as specified in Definition 9, so to determine an optimal shift r*₁∈[0, u) associated with a subimage I_{(r*}_{₁}_{, 0, . . . , 0)} that is maximal in the list {I₍ᵣ_{₁}_{, 0, . . . , 0)}:r₁∈[0, u)}. The axis-separated strategy then works on the (n₁, un₂, . . . , un_{d})-shaped subimage I_{(r*}_{₁}_{, 0, . . . , 0)} along the second spacetime axis by examining its stride-(1, u, . . . , 1) subimages listed as {I_{(r*}_{₁}_{, r}_{₂}_{, . . . , 0)}:r₂∈[0, u)}, each of which is (n₁, n₂, . . . , un_{d})-shaped. A similar method and step of spectral comparison is used to find a maximal subimage I_{(r*}_{₁}_{, r*}_{₂}_{, . . . , 0)} and determine the optimal shift r*₂∈[0, u). The same axis-separated strategy continues working on the progressively smaller subimages along each of the remaining spacetime axes until the last, so to determine the whole vector r*=(r*₁, r*₂, . . . , r*_{d}) of optimal shifts associated with the last maximal subimage I_{(r*}_{₁}_{, r*}_{₂}_{, . . . , r*}_{_{d}}₎, which is (n₁, n₂, . . . , n_{d})-shaped.

It is useful to note that the above exemplary embodiment has the same number u∈ [symbol] for the stride or USF along each of the d∈ [symbol] spacetime axes, which is only by way of examples and by no way of limitations. In general, different spacetime axes can have strides or USFs valued differently. It should be obvious to one skilled in the art that the above-specified methods and steps can be applied straightforwardly or adopted similarly when a (u₁n₁, u₂n₂, . . . , u_{d}n_{d})-shaped image is decomposed into stride-(u₁, u₂, . . . , u_{d}) subimages, each of which is (n₁, n₂, . . . , n_{d})-shaped, for any (u₁, u₂, . . . , u_{d})∈ [symbol] ^{d} and any (n₁, n₂, . . . , n_{d})∈ [symbol] ^{d}.

Still specifically, during each particular step of said axis-separated strategy working on one image (itself may be a subimage in a previous step) along a certain k-th axis, k∈[1, d] by examining its stride-(1, . . . , uₖ, . . . , 1) subimages to determine an optimal shift r*ₖ∈[0, uₖ), uₖ∈ [symbol] , an interpolation or spline method can be employed to fit the uₖ subimages into an image-valued continuous curve or function along the k-th spacetime axis, which provides an image corresponding to any arbitrarily real-valued number in the continuous interval [0, uₖ). In particular, the Fourier-transformed subimages and their spectral components also fit into continuous curves or functions along the k-th spacetime axis. Consequently, the spectral comparison can determine an optimal shift r*ₖ∈[0, uₖ) that is not integer-valued, corresponding to a maximal subimage that is an interpolation result different from the original list of subimages indexed by an integer rₖ∈[0, uₖ) along the k-th spacetime axis. In this mode of operation involving an interpolation or spline method, it may be advantageous and convenient to choose nₖ=1 and uₖ=uₖnₖ, namely, to choose a stride uₖ that is as large as the array length (or called array width or array size) along the k-th spacetime axis, ∀k∈[1, d]. By using interpolation or spline of subimages, an optimal image positioning procedure can determine an optimal shift r*∈ [symbol] ^{d} that has a rational—as well as irrational—valued number.

In accordance with the extended preprocessor for optimal image positioning, said extended module of shift forward firstly upsamples the original input image forwarded by the extended preprocessor by the same USF u∈ [symbol] or USFs u∈ [symbol] ^{d} used in the extended preprocessor, then shifts forward the upsampled image by the optimal shift r* that is exported from the extended preprocessor, finally downsamples the shifted image by the same factor u∈ [symbol] or factors u∈ [symbol] ^{d}, and outputs the downsampled image, which enters and gets processed by the CNN module to produce a CNN output image. Similarly, said extended module of shift backward firstly upsamples the CNN output image that it receives by the same USF u∈ [symbol] or USFs u∈ [symbol] ^{d} used in the extended preprocessor, then shifts backward the upsampled image by the optimal shift r* that is exported from the extended preprocessor, finally downsamples the shifted image by the same factor u∈ [symbol] or factors u∈ [symbol] ^{d}, and outputs the downsampled image as the final output image of the extended system of FIG. 7. When an interpolation or spline method is used by the extended preprocessor to fit subimages into a continuous curve and determine an optimal shift r*∈ [symbol] ^{d} that has a rational—as well as irrational—valued number, the shift forward or backward operation in the extended shift forward or backward module would also use interpolation or spline to compute an interpolated image between integral-shifted (in units of the corresponding subpixel of the upsampled image) images, which corresponds to the rational—or irrational—valued number. Furthermore, it is also advantageous to adopt an axis-separated strategy, perform a forward or backward shift of image along each spacetime axis separately, and repeat such per-axis shifts d times for all of the spacetime directions.

### Illustrated Exemplary Embodiments

In this specification, the terms signal and image are used interchangeably to refer to a physical quantity, or its digitized representation on a computer, that is distributed in a region of space or time, or spacetime jointly. Also, the terms signal processing method or procedure or step, circuit, network, system, and function having images or signals as input and output data or variables are used interchangeably to refer to either a physical device or method of signal processing that is represented by a directed graph of signal transformations.

Linear systems or networks [1] are the best studied and understood in the vast universe of systems or networks, while nonlinear systems or networks, which include all systems or networks that are not linear systems or networks, are more general and closer to physical realities but less understood. An important class of nonlinear systems or networks form a subset of the well-known Wiener-Volterra systems, which have been widely applied in the fields of computational physics and engineering, especially computational lithography [4, 24, 25, 29]. Such a Wiener-Volterra system or network has the great property that a band-limited input image or signal with a bandwidth W is transformed into a band-limited output image or signal whose bandwidth is no more than pW with p∈ [symbol] being a fixed integer, such that spectrum overlapping and aliasing can be avoided completely by upsampling the input, intermediate, and output images or signals by a USF=p. A Wiener-Volterra system or network is characterized by the following three simultaneous properties: 1) when the input magnitude of the input signals becomes sufficiently large and continues to grow, the output magnitude of the output signal grows asymptotically as a p-th power of the input magnitude, p∈ [symbol] ; 2) the bandwidth of the output signal is upper-bounded by an integer p times of the bandwidth of the input signal; 3) taking partial Fréchet derivatives [44] of the output signal with respect to the input signals for more than an integer p times produces an identically zero-valued signal.

In this specification, the terms Volterra system or network, Wiener system or network, Wiener-Volterra system or network, Wiener polynomial, Wiener polynomial operation or step, or just polynomial operation or polynomial function on images or signals, Volterra activation, Wiener activation, Wiener-Volterra activation, or just polynomial activation are used interchangeably to refer to either a functional block or a method or module or procedure or step of signal processing that involves or can be embodied as a step of applying a plurality of linear translation-invariant (LTI) convolutions on a plurality of input images or signals to generate a plurality of convolved images or signals, followed by a step of applying a pointwise polynomial (PWP) function or operation on said plurality of convolved images or signals to produce a Wiener result, and a final step of applying another LTI convolution on the Wiener result to generate an output signal, where said another LTI convolution on the Wiener result can be just an identity function or a constant scaling operation (namely, multiplying an image or signal by a scalar constant), while said PWP function or operation involves no more than three types of operations: pointwise multiplications between images or signals, constant scaling of images or signals (namely, multiplying images or signals by a scalar constant), summing up a plurality of images or signals including constant-valued images or signals into one signal.

Systems or networks are said to be non-polynomial when their input-output relationship can not be represented by a Wiener polynomial, or just a polynomial in short. Such non-polynomial systems or networks, also called non-polynomials in short, are characterized by a violation of at least one of the above-mentioned three simultaneous properties that characterize a Wiener polynomial. Wiener-Padé systems or networks constitute one important class of non-polynomials, which are probably the simplest non-polynomials, but already universal and efficient to approximate any CNN to any prescribed accuracy [9,11,12], including the widely used neural CNNs involving LTI convolutions and nonlinear activation functions such as the sigmoid, hyperbolic tangent, ReLU, Swish, max pooling, Softmax, and SoftPool, etc.

In this specification, the terms Wiener-Padé system or network, Wiener-Padé operation, Wiener-Padé function, Wiener-Padé activation, rational system or network, or rational function, or rational activation are used interchangeably to refer to either a functional block or a method or module or procedure or step of signal processing that involves two Wiener polynomials applied on the same input images or signals to produce a numerator result and a denominator result respectively, whose pointwise quotient provides an output image or signal.

Another useful class of non-polynomials are called scalar Euclidean-invariant (SEI) functions, which take an image or signal as an input, produce a single scalar-valued output, and have the property of Euclidean invariance, namely, the value of the output remains invariant when the input image or signal, usually being a multi-component data array or vector, undergoes many Euclidean transformations, also called rigid transformations or Euclidean isometries [45]. Specifically, said Euclidean transformations are geometric transformations of a Euclidean space that preserves the Euclidean distance between every pair of points. Said Euclidean transformations include spacetime translations (shifts), rotations about a fixed point, and reflections about a line, plane, or hyperplane, as well as any combinations/compositions of the named transformations. Examples of SEI functions include the well-known norms or norm functions ∥·∥ of an image or signal as a vector [46], and any composition ƒ(∥·∥) of a single-variable, scalar-in-scalar-out function ƒ(·) with a norm function ∥·∥, which maps a scalar-valued norm to a scalar output.

Being a single scalar-valued and having no finite spectral bandwidth defined, the SEI functions have no problem of aliasing to worry about, and they can be combined with any set of aliasing-free functions to generate a superset of aliasing-free functions. A function or transformation aJ+b [symbol] , called a scalar affine transformation (SAT), takes an input image or signal J and produces a scaled and value-shifted image or signal as output, where a∈ [symbol] and b∈ [symbol] are scalar-valued and called the affine coefficients associated with said SAT, while [symbol] is a constant image or signal having the same shape as J and all pixels unit-valued. When a and b are constants, the SAT aJ+b [symbol] , called a constant scalar affine transformation (constant SAT), is obviously a simple polynomial that is aliasing-free and Euclidean-invariant. When either a or b is an SEI function of a variable image I that may or may not be the same as J, the SAT a(I)J±b(I) [symbol] , called an scalar Euclidean-invariant scalar affine transformation (SEI SAT), could become a non-polynomial but is still aliasing-free and Euclidean-invariant. This is a very important and useful property that can be employed to regulate the magnitudes of images or signals for systems or networks to function properly. It is also important and useful to note that the set of all SEI SATs includes all constant SATs as special cases, when the SEI coefficients a(I) and b(I) reduce to constant functions.

In particular, there are two types of compositions of an SEI SAT a(I)J+b(I) [symbol] and an aliasing-free Wiener-Volterra polynomial W(·), one having the SEI SAT followed by the aliasing-free Wiener-Volterra polynomial as W(a(I)J+b(I)), the other having the aliasing-free Wiener-Volterra polynomial followed by the SEI SAT as a(I)W(J)+b(I) [symbol] , both of which can become a non-polynomial but are still aliasing-free and Euclidean-invariant. The set of functions that are generated by compositions of a plurality of said two types of compositions are called essentially Wiener-Volterra polynomial functions, or essentially Wiener-Volterra polynomials, or essentially polynomial functions, or essentially polynomial operations, or essentially polynomial transformations. By the well-known Stone-Weierstrass theorem [4,29,47], the set of all Wiener-Volterra polynomial functions are already universal and complete to approximate arbitrarily well any continuous systems, networks, or functions that take input images or signals from a compact domain of images or signals with an upper-bounded norm, because whenever necessary, an SEI function can be called to adjust the magnitude of an image or signal to within a desired range.

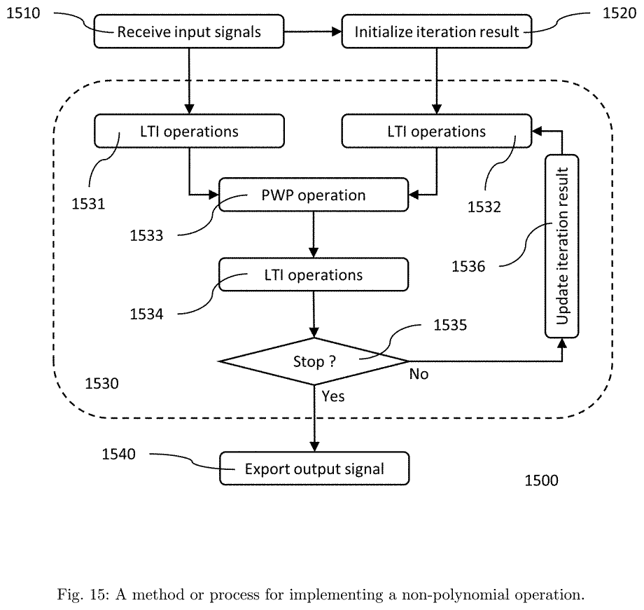

According to an exemplary embodiment, FIG. 15 illustrates one method or process 1500 for implementing a non-polynomial operation on a plurality of input signals to produce an output signal, where the plurality of input signals and the output signal and a pointwise reciprocal of the output signal constitute a first collection of signals. Method or process 1500 comprises a step 1510 of receiving the plurality of input signals, a step 1520 of initializing a variable signal named iteration result, an iterative procedure 1530, and a step 1540 of exporting an output signal. In FIG. 15, the iterative procedure 1530 is illustrated by the assembly inside the box enclosed by a dashed line.

Method or process 1500 can be incorporated into a software system and related computer program products. Method or process 1500 can involve computer-readable source and machine codes as well as numerical data, which are stored, processed, and executed by a hardware system and related physical device. Method or process 1500 can also be incorporated into a hardware system and related hardware products. Such hardware systems and hardware products include but are not limited to integrated circuits for digital signal processing (DSP), integrated circuits for image processing, integrated circuits for manipulating computer graphics, integrated circuits for processing data arrays, integrated circuits for processing multi-dimensional data arrays (also known as tensors), general-purpose computing devices, general-purpose computing machines, physical devices involving a central processing unit (CPU), physical devices involving a graphics processing unit (GPU), physical devices involving a tensor processing unit (TPU).

Each iteration of the iterative procedure 1530 is also called an aliasing-free polynomial (AFP) operation, which comprises a step 1531 that applies a plurality of first linear translation-invariant (LTI) operations on the plurality of input signals to produce a plurality of convolved inputs, a step 1532 that applies a plurality of second LTI operations on the iteration result to produce a plurality of convolved iteration results, and a step 1533 that applies a pointwise polynomial (PWP) operation on a second collection of signals to produce a Wiener model result (WMR), where the second collection of signals comprise the plurality of convolved inputs and the plurality of convolved iteration results. The AFP operation further comprises a step 1534 that applies a third LTI operation on the WMR to produce a convolved WMR, a halting mechanism 1535 that makes a Yes versus No decision, and an updating mechanism 1536 that replaces values of the iteration result by values of the convolved WMR upon the halting mechanism 1535 making a No decision. The LTI operations applied in step 1531 and step 1532 control or limit the spectra of the second collection of signals, such that the PWP operation applied in step 1533 is aliasing-free as it causes no spectrum overlapping while producing the WMR.

Upon halting mechanism 1535 making a Yes decision, iterative procedure 1530 stops repeating the AFP operation, and step 1540 exports the iteration result as the output signal, with which, the first collection of signals substantially satisfy a prescribed polynomial equation, where the polynomial equation implicitly defines a non-polynomial function that operates on the plurality of input signals to produce the output signal.

Each of said first, second, and third LTI operations applied in step 1531, step 1532, and step 1534 on a correspondingly specified signal can be selected from a collection of choices, which comprises any conventional convolution [1] between the specified signal and a convolution kernel (also known as a filter, an impulse, a kernel, or a filter response, an impulse response, a kernel function, etc.), and any pointwise multiplication between a Fourier-transformed version of the specified signal and a transfer function [1] (also known as a frequency transfer function, a frequency filter, a frequency response, a spectral window, or a window function, etc.), as well as the identity function that passes the specified signal straightly through, and any scalar multiplier that multiplies the specified signal by a scalar constant. In particular, the collection of choices for the LTI operations includes upsampling and downsampling specified signals to control or limit their spectra to avoid spectrum overlapping and aliasing.

Method or process 1500 obviously embodies a canonical Wiener system or network or a Wiener polynomial [4,24,25,29]. It can also implement any Volterra system that is a sum of Volterra multiple integrals for one simple reason that Volterra systems or networks and Wiener systems or networks are two equivalent representations for the same class of nonlinear systems or networks [4, 24, 25]. Furthermore, any Volterra multiple integral can be directly interpreted as a composition of a PWP function applied on a plurality of input signals followed by a single LTI operation with the Volterra kernel serving as a multi-dimensional convolution kernel.

According to another exemplary embodiment, said halting mechanism 1535 makes a Yes decision upon said AFP operation having been repeated for a prescribed number of times. According to yet another exemplary embodiment, said halting mechanism 1535 makes a Yes decision upon said convolved WMR is substantially the same as said iteration result. Each exemplary embodiment is given by way of example but no means of limitation.

One exemplary method or process implements a non-polynomial network 0016 transforming a plurality of global input signals as a set [symbol] _{*} [symbol] {I:I∈ [symbol] _{*}} to a desired global output signal J_{*}. The input-output relationship between [symbol] _{*} and J_{*} can not be represented by a Wiener polynomial. Said exemplary method or process comprises a step of receiving said plurality of global input signals as a set [symbol] _{*,} a means of providing an ordered list [symbol] {Pᵢ:i∈[1, N]}, N∈ [symbol] of essentially polynomial operations, where, for each i∈[1, N], the essentially polynomial operation Pᵢ acts on a plurality of first local input signals as a set [symbol] ᵢ [symbol] {I:I∈ [symbol] ᵢ} to produce a first local output signal Jᵢ which belongs to a plurality of local output signals as a set [symbol] {Jₖ:k∈[1, N]}, namely, Jᵢ∈ [symbol] . For each i∈[1, N], the plurality of first local input signals [symbol] ₜ as a set is contained in the union of the plurality of global input signals as a set [symbol] _{*} and the plurality of local output signals as a set [symbol] , namely, [symbol] ᵢ⊆ [symbol] _{*}∪ [symbol] . Means for providing and ordering the ordered list of essentially polynomial operations {Pᵢ:i∈[1, N]} as well as connecting the local input and local output signals therein are such that the local output signal J_{N} produced by the last essentially polynomial operation P_{N} in the ordered list is substantially the same as the desired global output signal J_{*}.

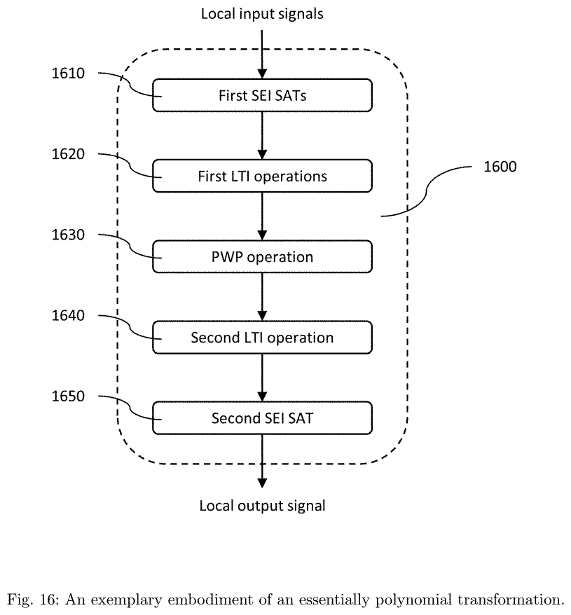

Among the essentially polynomial operations in said ordered list [symbol] , at least one Pᵢ with i∈[1, N] is implemented as essentially polynomial operation 1600 in FIG. 16, which acts on said plurality of first local input signals as a set [symbol] ᵢ to produce said first local output signal J₂. Said essentially polynomial operation 1600 comprises a plurality of first scalar Euclidean-invariant scalar affine transformations (SEI SATs) 1610 acting on a plurality of second local input signals to produce a plurality of second local output signals, a plurality of first linear translation-invariant (LTI) operations 1620 on a plurality of third local input signals to produce a plurality of third local output signals, a pointwise polynomial (PWP) operation 1630 on a plurality of fourth local input signals to produce a fourth local output signal, a second LTI operation 1640 on a fifth local input signal to produce a fifth local output signal, and a second SEI SAT 1650 acting on a sixth local input signal to produce a sixth local output signal. Said PWP operation 1630 is aliasing-free. At least one SEI SAT selected from the collection of said second SEI SAT 1650 and said plurality of first SEI SATs 1610 is associated with at least one affine coefficient that is a non-polynomial function of at least one signal selected from said plurality of first local input signals as a set [symbol] ᵢ.

FIG. 16 shows one exemplary means of interconnecting the operations or steps that are numbered as 1610, 1620, 1630, 1640, and 1650, where the plurality of second local input signals are substantially the same as the plurality of first local input signals, the plurality of third local input signals are substantially the same as the plurality of second local output signals, the plurality of fourth local input signals are substantially the same as the plurality of third local output signals, the fifth local input signal is substantially the same as the fourth local output signal, and the sixth local input signal is substantially the same as the fifth local output signal, while the first local output signal Jᵢ is substantially the same as the sixth local output signal.

It should be obvious to one skilled in the art that the operations or steps numbered as 1610, 1620, 1630, 1640, and 1650 can be interconnected in another similar or equivalent manner to yield an operation or function that is similar or equivalent to essentially polynomial operation 1600 in FIG. 16, so long as said another similar or equivalent manner of interconnecting the operations or steps numbered as 1610, 1620, 1630, 1640, and 1650 satisfies the following conditions conjointly:
1. said plurality of second local input signals are selected from a first pair of choices, with one choice being said plurality of first local input signals, while the other choice being said plurality of third local output signals;
2. said plurality of third local input signals are selected from a second pair of choices, with one choice being said plurality of first local input signals, while the other choice being said plurality of second local output signals;
3. said plurality of fourth local input signals are selected from a third pair of choices, with one choice being said plurality of second local output signals, while the other choice being said plurality of third local output signals;
4. said fifth local input signal is selected from a fourth pair of choices, with one choice being said fourth local output signal, while the other choice being said sixth local output signal;
5. said sixth local input signal is selected from a fifth pair of choices, with one choice being said fourth local output signal, while the other choice being said fifth local output signal;
6. said first local output signal is selected from a sixth pair of choices, with one choice being said fifth local output signal, while the other choice being said sixth local output signal.

Said PWP operation 1630 is aliasing-free by avoiding raising any signal belonging to said plurality of fourth local input signals to an excessively high-ordered power or pointwise-multiplying an excessively larger number of signals belonging to said plurality of fourth local input signals to produce said fourth local output signal, so to ensure that no spectrum overlapping and aliasing takes place in said fourth local output signal. Furthermore, said plurality of first LTI operations 1620 are configured accordingly to produce said plurality of third local output signals having a sufficient spectral guard band to avoid spectrum overlapping when said PWP operation 1630 acts on said plurality of fourth local input signals, where said plurality of fourth local input signals are substantially the same as either said plurality of third local output signals or said plurality of second local output signals produced by said plurality of first SEI SATs 1610 acting on said plurality of second local input signals, with said plurality of second local input signals being substantially the same as said plurality of third local output signals. In one exemplary embodiment, said plurality of first LTI operations 1620 involve upsampling elements in said plurality of third local input signals to create said sufficient spectral guard band.

According to one exemplary embodiment, said non-polynomial network 0016 is the entirety of a signal processing network that is associated with a non-polynomial function. According to another exemplary embodiment, said non-polynomial network 0016 is a part or a portion of a larger signal processing network, where said part or portion of said larger signal processing network is associated with a transformation between a plurality of input signals to an output signal, with said transformation being characterized by a non-polynomial function. According to yet another exemplary embodiment, said larger signal processing network produces a plurality of output signals. Each exemplary embodiment is given by way of example but no means of limitation.

Exemplary embodiments supra have specified methods, processes, or systems for signal processing that are completely aliasing-free and scalar Euclidean-invariant (invariant under scalar Euclidean transformations), namely, the effects, operations, or responses of the methods, processes, or systems remain invariant when the input signals undergo a scalar Euclidean transformation and the output signals undergo the inverse of the same scalar Euclidean transformation. Many practical applications require only spacetime shift invariance, namely, invariance under spacetime shifts (or called spacetime translations, as a specific class of scalar Euclidean transformations), for which, there are advantageous embodiments that incur a reduced computational cost.

A system or network of signal processing can be considered as a directed graph of signal transformations, with each graph vertex (or just called vertex in short) representing a point of signal state, or a point of signal input or output, or a point of signal observation or measurement, and each directed graph edge (or just called directed edge in short) signifying a function, or a mapping, or a transformations between an antecedent (or called input) signal and a descendant (or called output) signal. Each directed edge is associated with precisely one antecedent (or called input) vertex and one descendent (or called output) vertex, with the antecedent vertex providing an antecedent signal and the descendent vertex providing a descendent signal. By contrast, each graph vertex may be attached to a plurality of incoming directed edges as well as a plurality of outgoing directed edges, where each incoming directed edge has the graph vertex as its descendent vertex, while each outgoing directed edge has the graph vertex as its antecedent vertex. Furthermore, a vertex having a plurality of incoming directed edges attached is understood as having the plurality of descendent signals associated with said plurality of incoming directed edges summed or combined at the vertex, whereas a vertex having a plurality of outgoing directed edges attached is interpreted as having the signal observed at the vertex duplicated (or copied, or fanned out) and fed to each of said outgoing directed edges as its antecedent signal. As such, any directed graph of signal transformations constitutes a system or network of signal processing, and any system or network of signal processing can be represented by a directed graph of signal transformations.

An input-output system refers to either the entirety or a portion of a system or network of signal processing, said input-output system being represented by a directed graph of signal transformations {{Vᵢ}, {Eᵢⱼ}, (i,j)∈[0, N]²}, N∈ [symbol] , where {Vᵢ:i∈[0, N]} is a set of vertices and {Eᵢⱼ:(i,j)∈[0,N]²} is a set of directed edges, each Vᵢ, i∈[0, N] corresponds to a physical point at which signal input, output, or observation takes place, each Eᵢⱼ, (i,j)∈[0, N]² is a directed edge having Vᵢ as its antecedent vertex and Vⱼ as its descendent vertex, said Eᵢⱼ, (i,j)∈[0, N]² corresponding to a mathematical function Fᵢⱼ(·) and representing a physical device, an algorithmic module, or another input-output system called an input-output subsystem, with Fᵢⱼ(·) transforming any input signal Iᵢ at the antecedent vertex Vᵢ to an output signal Iⱼ=Fᵢⱼ(Iᵢ) at the descendant vertex Vⱼ, finally, the vertices are indexed such that no directed edge Eᵢⱼ, ∀(i,j)∈[0, N]² has V₀ as its antecedent vertex or V_{N} as its descendent vertex.

The vertex V₀ is called the input port and V_{N} the output port of the input-output system. The signals I₀ observed at V₀ and I_{N} observed at V_{N} are called respectively the input or incoming signal and the output or outgoing signal of the input-output system. The input-output system or the directed graph {{Vᵢ}, {Eᵢⱼ}, (i,j)∈[0, N]²} implements a composite function G(·) that transforms any incoming signal I₀ to an outgoing signal I_{N}=G(I₀). The function G(·) is also called the functional relationship between the incoming signal and the outgoing signal. Such a functional relationship or the corresponding input-output system is called shift-invariant for a given application that is concerned with either continuous-valued shift vectors {δx}⊆ [symbol] ^{d} or discrete-valued shift vectors {δx}⊆ [symbol] ^{d}, d∈ [symbol] , if for any shift vector δx∈ [symbol] ^{d} with [symbol] ∈{ [symbol] }, there exists a shift vector by δ_{y}∈ [symbol] ^{d}, such that G(T_{δx}I₀)=T_{δy}G(I₀) holds for any any incoming signal {I₀(x):x∈ [symbol] ^{d}}. Otherwise, said functional relationship or the corresponding input-output system is called shift-variant, if there exist a shift vector δx∈ [symbol] ^{d}, such that for any shift vector δy∈ [symbol] ^{d}, the equation G(T_{δx}I₀)=T_{δy}G(I₀) does not hold for all incoming signals.

For many applications, it is desired to make a shift-variant input-output system shift-invariant, namely, making the functional relationship between the incoming signal and the outgoing signal of the input-output system shift-invariant.

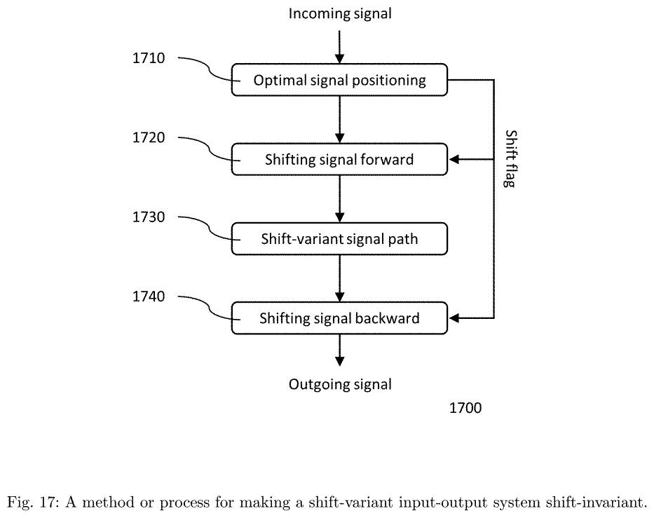

According to an exemplary embodiment, FIG. 17 illustrates one method 1700 for making a shift-variant input-output system shift-invariant. Method 1700 comprises a step 1710 of providing an optimal signal positioning step that acts on an incoming signal to produce a first local signal in conjunction with a shift flag, a step 1720 of providing a shifting signal forward step that receives said shift flag and acts on said first local signal to produce a second local signal that is shifted with respect to said first local signal in accordance with said shift flag, a step 1730 that feeds said second local signal to said shift-variant input-output system to produce a third local signal, and an exporting step that receives said third local signal and exports an outgoing signal. The steps 1710, 1720, 1730 and the exporting step are coordinated such that the functional relationship between said incoming signal and said outgoing signal is shift-invariant.

According to an exemplary embodiment, step 1710 further comprises a sub-step of preparing said incoming signal into a prepared signal which is an array of signal points indexed along a plurality of spacetime axes, a sub-step of providing and initializing a prepared vector comprising a plurality of components along said plurality of spacetime axes, a sub-step of providing an iterative procedure that repeats an iterative step for a predetermined number of iterations, and a sub-step of exporting said optimal shift vector as said shift flag and exporting said first local signal upon termination of said iterative procedure. In one exemplary embodiment, said first local signal is substantially the same as said incoming signal. In another exemplary embodiment, said first local signal is substantially the same as said prepared signal. In yet another exemplary embodiment, said first local signal is a sub-signal (of said incoming signal) that includes a portion of the sampling points or pixels contained by said incoming signal. In still another exemplary embodiment, said first local signal is a sub-signal (of said prepared signal) that includes a portion of the sampling points or pixels contained by said prepared signal.

In one exemplary embodiment, said sub-step of preparing is substantially a relay step which receives said incoming signal and exports said prepared signal that is substantially the same as said incoming signal. In another exemplary embodiment, said sub-step of preparing receives and upsamples said incoming signal to produce said prepared signal that is upsampled with respect to said incoming signal, namely, the prepared signal contains more sampling points or pixels than the incoming signal. In yet another exemplary embodiment, said sub-step of preparing receives and upsamples said incoming signal to produce a resampled signal, then performs a pointwise nonlinear operation on said resampled signal to produce said prepared signal, such that the prepared signal is also upsampled with respect to said incoming signal, namely, the prepared signal contains more sampling points or pixels than the incoming signal. Said pointwise nonlinear operation on said resampled signal is to apply a nonlinear function pointwise to each sampling point or pixel of the resampled signal, where said nonlinear function takes as input an old value from each sampling point or pixel, computes a new value as output, and writes the new value to said each sampling point or pixel. Examples of said nonlinear function include a polynomial, a rational function, a radical function that computes the root of a polynomial equation, a trigonometry function, a sigmoid function, a hyperbolic tangent function, etc.

According to an exemplary embodiment, said iterative step further comprises a sub-sub-step of decomposing said prepared signal into a plurality of non-overlapping sub-signals (NOSSs) with each of said plurality of NOSSs being associated with a shift vector having components along said plurality of spacetime axes, a sub-sub-step of computing a plurality of spectral density vectors (SDVs) with each of said plurality of SDVs corresponding to one of said plurality of NOSSs, a sub-sub-step of comparing said plurality of SDVs according to a predetermined partial order and estimating an optimal SDV that corresponds to an optimal NOSS with said optimal NOSS being associated with an optimal shift vector, a sub-sub-step of providing a second updating mechanism that incorporates said optimal shift vector into said prepared vector, and a sub-sub-step of providing a second updating mechanism that replaces values of said prepared signal by values of said optimal NOSS in case said predetermined number of iterations is greater than 1. In said sub-sub-step of decomposing said prepared signal into said plurality of NOSSs, the plurality of NOSSs comprise at least a first NOSS associated with a first shift vector and a second NOSS associated with a second shift vector where said first shift vector and said second shift vector have a different component along at least one of said plurality of spacetime axes. In said sub-sub-step of comparing said plurality of SDVs and estimating said optimal SDV, the optimal SDV is either substantially before or substantially after all of said plurality of SDVs in said predetermined partial order, with said predetermined partial order being reflexive, or called weak, or or called non-strict, in that any SDV is both before and after itself in the predetermined partial order.

In one exemplary embodiment, said predetermined number of iterations is 1, and said iterative procedure executes said iterative step only once. In another exemplary embodiments, said predetermined number of iterations is n≥2, and said iterative procedure iterates said iterative step for n times, such that within each iteration, said first shift vector and said second shift vector are different but both contained in a unique subspace spanned by a unique collection of spacetime axes selected from said plurality of spacetime axes, while different iterations have disjoint unique subspaces spanned by disjoint unique collection of spacetime axes. Such an axis-separated strategy has the advantage of reduced computational complexity in comparing said plurality of SDVs and estimating an optimal SDV.

In one exemplary embodiment, each of said plurality of NOSSs is Fourier transformed to produce a corresponding spectral signal or image in the frequency domain, then the magnitude of the value at each signal point or pixel of said corresponding spectral signal or image is computed to constitute a spectral density signal or image [48]. Said spectral density signal or image has the advantage of remaining invariant when the corresponding said each of said plurality of NOSSs undergoes a spacetime shift. The values of the sampling points or pixels of said spectral density signal or image could be squared or processed by another pointwise function. Each of said plurality of SDVs corresponding to said one of said plurality of NOSSs comprises a number of values of the sampling points or pixels of said spectral density signal or image computed from said one of said plurality of NOSSs. Alternatively, each of said plurality of SDVs corresponding to said one of said plurality of NOSSs comprises a number of values that are computed from said number of functions of said spectral density signal or image computed from said one of said plurality of NOSSs.

In one exemplary embodiment, said each of said plurality of SDVs is at least two-dimensional and comprises at least two components computed from different functions of the corresponding one of said plurality of NOSSs. In another exemplary embodiment, said estimating said optimal SDV comprises an interpolation step that produces said optimal SDV by interpolating a portion of said plurality of SDVs, such that the corresponding optimal shift vector can have a non-integer-valued component or a coordinate that is off-grid of the sampling point or pixel of the prepared image.

In one exemplary embodiment, said exporting step receives said third local signal and exports said outgoing signal that is substantially the same as said third local signal, whereby the functional relationship between said incoming signal and said outgoing signal is shift-invariant. In another exemplary embodiment, said exporting step receives said third local signal and provides a shifting signal backward step that receives said shift flag and acts on said third local signal to produce said outgoing signal, whereby the functional relationship between said incoming signal and said outgoing signal is shift-invariant.

### REFERENCES

1. A. V. Oppenheim and A. S. Willsky, Signals & Systems, 2nd Ed. (Prentice-Hall, 1997).
2. X. Ma and G. R. Arce, Computational Lithography (John Wiley & Sons, 2010).
3. A. Erdmann, Optical and EUV Lithography: A Modeling Perspective (SPIE Press, 2021).
4. W. J. Rugh, Nonlinear System Theory: The Volterra/Wiener Approach (Johns Hopkins University Press, 1981).
5. W. Zhang, K. Itoh, J. Tanida, and Y. Ichioka, “Parallel distributed processing model with local space-invariant interconnections and its optical architecture,” Appl. Opt., vol. 29, no. 32, pp. 4790-4797 (1990).
6. W. Zhang et al., “Computerized detection of clustered microcalcifications in digital mammograms using a shift-invariant artificial neural network,” Med. Phys., vol. 21, no. 4, pp. 517-524 (1994).
7. Y. LeCun and Y. Bengio, “Convolutional networks for images, speech, and time series,” in M. A. Arbib (ed.), The Handbook of Brain Theory and Neural Networks, 2nd Ed. (MIT Press, 1995).
8. Y. LeCun, L. Bottou, Y. Bengio, and P. Haffner, “Gradient-based learning applied to document recognition,” Proc. IEEE, vol. 86, no. 11, pp. 2278-2324 (1998).
9. M. Telgarsky, “Neural networks and rational functions,” Proc. 34th Int. Conf. Mach. Learn., Sydney, Australia
10. P. Ramachandran, B. Zoph, and Q. V. Le, “Searching for Activation Functions,” arXiv preprint, arXiv:1710.05941 [cs.NE] (2017).
11. A. Molina, P. Schramowski, and K. Kersting, “Padé activation units: End-to-end learning of flexible activation functions in deep networks,” arXiv preprint, arXiv:1907.06732 [cs.LG] (2019).
12. Q. Delfosse, P. Schramowski, M. Mundt, A. Molina, and K. Kersting, “Deep rational reinforcement learning,” arXiv preprint, arXiv: 2102. 09407 [cs.LG] (2021).
13. A. Stergiou, R. Poppe, and G. Kalliatakis, “Refining activation downsampling with SoftPool,” arXiv:2101.00440 [cs.CV]
14. M. Gustineli, “A survey on recently proposed activation functions for Deep Learning,” arXiv preprint, arXiv:2204.02921 [cs.LG] (2022).
15. A. Fawzi and P. Frossard, “Manitest: Are classifiers really invariant?” arXiv preprint, arXiv:1507.06535 [cs.CV] (2015).
16. L. Engstrom, B. Tran, D. Tsipras, L. Schmidt, and A. Madry, “Exploring the landscape of spatial robustness,” arXiv preprint, arXiv: 1712. 02779 [cs.LG] (2017).
17. A. Azulay and Y. Weiss, “Why do deep convolutional networks generalize so poorly to small image transformations?” J. Mac. Learn. Res., vol. 20, pp. 1-25 (2019).
18. Y. Gong and C. Poellabauer, “Impact of aliasing on deep CNN-based end-to-end acoustic models,” Proc. Interspeech 2018, pp. 2698-2702 (2018).
19. L. Ruthotto and E. Haber, “An introduction to deep generative modeling,” arXiv preprint, arXiv:2103.05180 [cs.LG] (2021).
20. G. Parmar, R. Zhang, and J.-Y. Zhu, “Aliased resizing and surprising subtleties in GAN evaluation,” arXiv preprint, arXiv:2104.11222 [cs.CV] (2021).
21. Y. Sui, O. Afacan, C. Jaimes, A. Gholipour, and S. K. Warfield, “Scan-specific generative neural network for MRI super-resolution reconstruction,” IEEE Trans. Med. Imag., vol. 41, no. 6, pp. 1383-1399 (2022).
22. R. Zhang, “Making convolutional networks shift-invariant again,” arXiv preprint, arXiv:1904.11486 [cs.CV] (2019).
23. J. Singh, A. Tripathy, P. Garg, and A. Kumar, “Lung tuberculosis detection using anti-aliased convolutional networks,” Procedia Computer Science, vol. 173, pp. 281-290 (2020).
24. M. Schetzen, The Volterra and Wiener Theories of Nonlinear Systems (John Wiley & Sons, 1980).
25. M. Schetzen, “Nonlinear system modeling based on the Wiener theory,” Proc. IEEE, vol. 69, no. 12, pp. 1557-1573 (1981).
26. G. A. Baker, Jr., Essentials of Padé Approximants (Academic Press, 1975).
27. Y. Granik, N. Cobb, and D. Medvedev, “Application of CM0 resist model to OPC and verification,” Proc. IEEE, vol. 6154, 61543E (2006).
28. Y. Granik, D. Medvedev, and N. Cobb, “Towards standard process models for OPC,” Proc. IEEE, vol. 6520, 652043 (2007).
29. H. Wei, “Computer simulation of photolithographic processing,” U.S. Pat. No. 8,532,964 B2, Date of patent: Sep. 10, 2013.
30. E. S. Wei, “Aliasing-free convolutional nonlinear networks using implicitly defined functions,” HAL open archive, hal-03475613 (2021).
31. E. S. Wei, “Aliasing-free nonlinear signal processing using implicitly defined functions,” IEEE Access, vol. 10, pp. 76281-76295, DOI: 10.1109/ACCESS.2022.3192387 (2022).
32. E. S. Wei, https://github.com/emswei/iCNN (2022).
33. T. Makela and R. Niemisto, “Effects of harmonic components generated by polynomial preprocessor in acoustic echo control,” Proc. International Workshop on Acoustic Echo and Noise Control (IWAENC 2003), Kyoto, Japan, pp. 139-142 (2003).
34. W. H. Press, S. A. Teukolsky, W. T. Vetterling, and B. P. Flannery, Numerical Recipes, 3rd Ed. (Cambridge University Press, 2007).
35. R. Larson and B. H. Edwards, Calculus of a Single Variable, 9th Ed. (Brooks/Cole, Cengage Learning, 2010).
36. R. E. Goldschmidt, “Applications of division by convergence,” M.Sc. Thesis, MIT (1964).
37. N. J. Higham, Functions of Matrices: Theory and Computation (SIAM, 2008).
38. J. Chen and E. Chow, “A stable scaling of Newton-Schulz for improving the sign function computation of a hermitian matrix,” Preprint ANL/MCS-P5059-0114 (https://www.mcs.anl.gov/papers/P5059-0114.pdf).
39. A. Chaman and I. Dokmanić, “Truly shift-invariant convolutional neural networks,” arXiv preprint, arXiv:2011.14214 [cs.CV] (2020).
40. M. R. Teague, “Deterministic phase retrieval: a Green's function solution,” J. Opt. Soc. Am., vol. 73, no. 11, pp. 1434-1441 (1983).
41. S. L. Valdarrama, “Convolutional autoencoder for image denoising,” https://keras.io/examples/vision/autoencoder (2021).
42. S. Schubert, P. Neubert, J. Pöschmann, and P. Protzel, “Circular Convolutional Neural Networks for Panoramic Images and Laser Data,” in Proc. Intel. Veh. Symp. (IV), DOI: 10.1109/IVS.2019.8813862 (2019).
43. Y. LeCun, C. Cortes, and C. J. C. Burges, “The MNIST database of handwritten digits,” http://yann.lecun.com/exdb/mnist (1998).
44. https://en.wikipedia.org/wiki/Fréchet_derivative
45. https://en.wikipedia.org/wiki/Rigid_transformation
46. https://en.wikipedia.org/wiki/Norm_(mathematics)
47. https://en.wikipedia.org/wiki/Stone-Weierstrass_theorem
48. https://en.wikipedia.org/wiki/Spectral_density

What is claimed is:

1. A method for implementing a non-polynomial operation on a plurality of input signals to produce an output signal, said plurality of input signals and said output signal and a pointwise reciprocal of said output signal constituting a first collection of signals, said method comprising:
receiving said plurality of input signals;
initializing a variable signal named iteration result;
providing an iterative procedure that repeats an aliasing-free polynomial (AFP) operation updating said iteration result, said AFP operation comprising:
applying a plurality of first linear translation-invariant (LTI) operations on said plurality of input signals to produce a plurality of convolved inputs;
applying a plurality of second LTI operations on said iteration result to produce a plurality of convolved iteration results;
applying a pointwise polynomial (PWP) operation on a second collection of signals to produce a Wiener model result (WMR), said second collection of signals comprising said plurality of convolved inputs and said plurality of convolved iteration results;
applying a third LTI operation on said WMR to produce a convolved WMR;
providing a halting mechanism that makes a Yes versus No decision;
providing an updating mechanism that replaces values of said iteration result by values of said convolved WMR upon said halting mechanism making a No decision;
whereby said PWP operation is aliasing-free, and said iterative procedure stops repeating said AFP operation upon said halting mechanism making a Yes decision;
exporting said iteration result as said output signal upon said halting mechanism making a Yes decision;
whereby said first collection of signals substantially satisfying a prescribed polynomial equation.

2. The method of claim 1, wherein said halting mechanism makes a Yes decision upon said AFP operation having been repeated for a prescribed number of times.

3. The method of claim 1, wherein said halting mechanism makes a Yes decision upon said convolved WMR is substantially the same as said iteration result.

4. A method for implementing a non-polynomial network transforming a plurality of global input signals to a desired global output signal, said method comprising:
receiving said plurality of global input signals;
providing an ordered list of essentially polynomial operations, each element in said ordered list of essentially polynomial operations acting on a plurality of first local input signals to produce a first local output signal belonging to a plurality of local output signals, each element in said plurality of first local input signals being selected from a collection of signals comprising said plurality of global input signals and said plurality of local output signals, at least one of said essentially polynomial operations comprising:
providing a plurality of first scalar Euclidean-invariant scalar affine transformations (SEI SATs) acting on a plurality of second local input signals to produce a plurality of second local output signals;
providing a plurality of first linear translation-invariant (LTI) operations on a plurality of third local input signals to produce a plurality of third local output signals;
providing a pointwise polynomial (PWP) operation on a plurality of fourth local input signals to produce a fourth local output signal, said PWP operation being aliasing-free;
providing a second LTI operation on a fifth local input signal to produce a fifth local output signal;
providing a second SEI SAT acting on a sixth local input signal to produce a sixth local output signal; wherein
said plurality of second local input signals are selected from a first pair of choices, with one choice being said plurality of first local input signals, while the other choice being said plurality of third local output signals;
said plurality of third local input signals are selected from a second pair of choices, with one choice being said plurality of first local input signals, while the other choice being said plurality of second local output signals;
said plurality of fourth local input signals are selected from a third pair of choices, with one choice being said plurality of second local output signals, while the other choice being said plurality of third local output signals;
said fifth local input signal is selected from a fourth pair of choices, with one choice being said fourth local output signal, while the other choice being said sixth local output signal;
said sixth local input signal is selected from a fifth pair of choices, with one choice being said fourth local output signal, while the other choice being said fifth local output signal;
said first local output signal is selected from a sixth pair of choices, with one choice being said fifth local output signal, while the other choice being said sixth local output signal;
at least one SEI SAT selected from the collection of said second SEI SAT and said plurality of first SEI SATs is associated with at least one affine coefficient that is a non-polynomial function of at least one signal selected from said plurality of first local input signals;
whereby the local output signal produced by the last item in said ordered list of essentially polynomial operations is substantially the same as said desired global output signal.

5. A method for making a shift-variant input-output system shift-invariant, said method comprising:
providing an optimal signal positioning step that acts on an incoming signal to produce a first local signal in conjunction with a shift flag, said optimal signal positioning step comprising:
preparing said incoming signal into a prepared signal, said prepared signal being an array of signal points indexed along a plurality of spacetime axes;
providing and initializing a prepared vector comprising a plurality of components along said plurality of spacetime axes;
providing an iterative procedure that repeats an iterative step for a predetermined number of iterations, said iterative step comprising:
decomposing said prepared signal into a plurality of non-overlapping sub-signals (NOSSs), each of said plurality of NOSSs being associated with a shift vector having components along said plurality of spacetime axes, said plurality of NOSSs comprising at least a first NOSS associated with a first shift vector and a second NOSS associated with a second shift vector, wherein said first shift vector and said second shift vector have a different component along at least one of said plurality of spacetime axes;
computing a plurality of spectral density vectors (SDVs), each of said plurality of SDVs corresponding to one of said plurality of NOSSs;
comparing said plurality of SDVs according to a predetermined partial order and estimating an optimal SDV that corresponds to an optimal NOSS, said optimal NOSS being associated with an optimal shift vector, wherein said optimal SDV is either substantially before or substantially after all of said plurality of SDVs in said predetermined partial order;
providing a first updating mechanism that incorporates said optimal shift vector into said prepared vector;
conditioned upon said predetermined number of iterations being greater than 1, providing a second updating mechanism that replaces values of said prepared signal by values of said optimal NOSS;
upon termination of said iterative procedure, exporting said prepared vector as said shift flag and exporting said first local signal;
providing a shifting signal forward step that receives said shift flag and acts on said first local signal to produce a second local signal, wherein said second local signal is shifted with respect to said first local signal in accordance with said shift flag;
providing a step that feeds said second local signal to said shift-variant input-output system to produce a third local signal;
providing an exporting step that receives said third local signal and exports an outgoing signal;
whereby the functional relationship between said incoming signal and said outgoing signal is shift-invariant.

6. The method of claim 5, wherein said prepared signal is upsampled with respect to said incoming signal.

7. The method of claim 5, wherein said predetermined number of iterations is 1.

8. The method of claim 5, wherein said predetermined number of iterations is greater than 1.

9. The method of claim 5, wherein said computing said plurality of SDVs comprises a step of Fouriertransforming each of said plurality of NOSSs.

10. The method of claim 5, wherein said each of said plurality of SDVs comprises at least two components computed from different functions of the corresponding one of said plurality of NOSSs.

11. The method of claim 5, wherein said estimating said optimal SDV comprises an interpolation step that produces said optimal SDV by interpolating a portion of said plurality of SDVs.

12. The method of claim 5, wherein said outgoing signal is substantially the same as said third local signal.

13. The method of claim 5, wherein said exporting step further providing a shifting signal backward step that receives said shift flag and acts on said third local signal to produce said outgoing signal.
